(19) United States
(12) Patent Application Publication
(10) Pub. No.: US 2026/0128780 A1
(43) Pub. Date: May 7, 2026

(54) METHODS AND SYSTEM FOR TIMELINE OF UE-INITIATED BEAM MANAGEMENT REPORTING

(71) Applicant: Samsung Electronics Co., Ltd., Suwon-si (KR)

(72) Inventors: Hoda Shahmohammadian, San Diego, CA (US); Mohamed Awadin, San Diego, CA (US); Jung Hyun Bae, San Diego, CA (US)

(21) Appl. No.: 19/367,195

(22) Filed: Oct. 23, 2025

Related U.S. Application Data
(60) Provisional application No. 63/717,693, filed on Nov. 7, 2024.

(51) Int. Cl. H04B 7/06; H04L 5/00

(52) U.S. Cl. CPC H04B 7/06952; H04B 7/0626; H04L 5/0044

(57) ABSTRACT

A system and a method are disclosed for implementing reporting timeline determination relating to UE-initiated beam reporting procedures. The reporting timeline determination may enable selection of the received beams to measure and include in the UE-initiated beam report in a manner that realizes improvements to beam reporting, including improving the accuracy and/or reliability of the information contained in the UE-initiated beam reports and reducing latency associated with the UE-initiated beam reporting transmissions. For example, a method may include transmitting a beam reporting indication message in the first uplink channel to initiate beam reporting, identifying a reference resource based on the second uplink channel and identifying beams to measure based on a relation of the beams to the reference resource. Measurements on the identified beams may be performed, and the beam report may be transmitted in the second uplink channel based on the measurement of the beams.

### CROSS-REFERENCE TO RELATED APPLICATION

This application claims the priority benefit under 35 U.S.C. § 119(e) of U.S. Provisional Application No. 63/717,693, filed on Nov. 7, 2024, the disclosure of which is incorporated by reference in its entirety as if fully set forth herein.

### BACKGROUND

### 1. Field

Aspects of some embodiments of the present disclosure generally relate to wireless communication systems. More particularly, the subject matter disclosed herein relates to improvements to beam management, including to beam reporting.

### 2. Description of the Related Art

Beam management may be utilized in wireless communication technology standards, such as 5G NR (New Radio) technology, for establishing, maintaining, and/or improving (e.g., optimizing) the directional transmission beams and reception beams between a general node B (gNB) (also referred to herein as a “base station”) and the User Equipment (UE). For example, wireless networks using 5G NR technology may often operate at relatively higher frequencies (e.g., 24.25 GHz to 71.0 GHz for high speeds and capacity), thereby signals may be more directionally driven and/or susceptible to blockage, path loss, and/or the like. Beam management may involve functions to assist in improving the strength, directional accuracy, quality, and reliability of beams in the wireless network. Beam management may involve serval functions that relate to the control and/or improved operation of the beams, including, but not limited to: beam sweeping; beam measurement; beam determination; beam reporting; and/or the like.

As used herein, “beam reporting” may refer to the algorithms, functions, and procedures in some wireless communication technology standards (e.g., 5G NR) that involve the UE communicating to the network, via the gNB, information relating to the signal qualities of various transmitted beams. Beam reporting may allow the gNB to maintain appropriate and/or improved signal quality, for example switching beams in order to achieve an improved operational performance and/or stability (e.g., uninterrupted data transfer). During beam reporting, UEs may perform measurements on candidate beams transmitted by a gNB and report the results, which can be used for beam selection, tracking, and recovery in response to channel dynamics, mobility, and/or beam failure.

The above information disclosed in this Background section is for enhancement of understanding of the background of the present disclosure, and therefore, it may contain information that does not constitute prior art.

### TECHNICAL FIELD

The disclosure generally relates to wireless communication networks. More particularly, the subject matter disclosed herein relates to improvements to beam management, including reporting timeline determination for beam reporting.

### SUMMARY

Aspects of some embodiments of the present disclosure generally relate to improvements to beam management, including reporting timeline determination for beam reporting. In some embodiments, a method for transmitting a beam report using a first uplink channel and a second uplink channel, may include: transmitting a beam reporting indication message in the first uplink channel to initiate beam reporting; identifying, at a User Equipment (UE), a reference resource based on the second uplink channel; identifying one or more beams to measure based on a relation of the one or more beams to the reference resource; performing measurements on the one or more beams; and transmitting the beam report in the second uplink channel based on the measurement of the one or more beams.

In some embodiments, the reference resource may be a Channel State Information (CSI) reference resource.

In some embodiments, identifying the reference resource may be based on determining a time for the CSI reference resource based on an aperiodic CSI reporting for the CSI reference resource.

In some embodiments, identifying the reference resource may be based on determining a time for the CSI reference resource relative to an uplink slot corresponding to the second uplink channel.

In some embodiments, determining the time for the CSI reference resource is based on a downlink slot corresponding to the CSI reference resource relative to the uplink slot.

In some embodiments, determining the time for the CSI reference resource may be based on a subcarrier spacing configuration for the downlink slot and an offset value.

In some embodiments, identifying the one or more beams to measure may be based on determining the one or more beams that are received at the UE before the determined time for the CSI reference resource.

In some embodiments, a method for transmitting a beam report using a first uplink channel and a second uplink channel may include: transmitting a beam reporting indication message in the first uplink channel to initiate beam reporting; identifying, at a UE, a reference resource based on the first uplink channel; identifying one or more beams to measure based on a relation of the one or more beams to the reference resource; performing measurements on the one or more beams; and transmitting the beam report in the second uplink channel based on the measurement of the one or more beams.

In some embodiments, the reference resource may be a CSI reference resource.

In some embodiments, identifying the reference resource may be based on determining a time for the CSI reference resource relative to a first symbol corresponding to the first uplink channel.

In some embodiments, identifying the one or more beams to measure may be based on determining the one or more beams that are received at the UE before the determined time for the CSI reference resource.

In some embodiment, a device for transmitting a beam report using a first uplink channel and a second uplink channel, may include: a processor; and a memory storing instructions that, based on being executed by the processor, cause the processor to: transmit a beam reporting indication message in the first uplink channel to initiate beam reporting; identify a reference resource based on the second uplink channel; identify one or more beams to measure based on a relation of the one or more beams to the reference resource; perform measurements on the one or more beams; and transmit the beam report in the second uplink channel based on the measurement of the one or more beams.

In some embodiments, the reference resource may be a CSI reference resource.

In some embodiments, identifying the reference resource may be based on determining a time for the CSI reference resource based on an aperiodic CSI reporting for the CSI reference resource.

In some embodiment, identifying the reference resource may be based on determining a time for the CSI reference resource relative to an uplink slot corresponding to the second uplink channel.

In some embodiments, determining the time for the CSI reference resource may be based on a downlink slot corresponding to the CSI reference resource relative to the uplink slot.

In some embodiments, determining the time for the CSI reference resource may be based on a subcarrier spacing configuration for the downlink slot and an offset value.

In some embodiments, identifying the one or more beams to measure may be based on determining the one or more beams that are received at the UE before the determined time for the CSI reference resource.

In some embodiments, identifying the reference resource may be based on determining a time for the CSI reference resource relative to a first symbol on the uplink slot corresponding to the second uplink channel.

In some embodiments, the device may be a UE and the transmitting the beam report is to a general node B (gNB).

### BRIEF DESCRIPTION OF THE DRAWING

In the following section, the aspects of the subject matter disclosed herein will be described with reference to exemplary embodiments illustrated in the figures.

FIG. 1 illustrates an example wireless network system implementing user equipment (UE)-initiated beam reporting, including reporting timeline determination functions, according to some embodiments of the present disclosure.

FIG. 2 is a block diagram illustrating an example UE device including a beam reporting circuit and reporting timeline determination circuitry for implementing the UE-initiated beam reporting functions of FIG. 1, according to some embodiments of the present disclosure.

FIG. 3A includes diagrams illustrating examples of reporting timelines determined based on a minimum time period implemented by the reporting timeline determination circuitry of FIG. 2, according to some embodiments of the present disclosure.

FIG. 3B includes diagrams illustrating other examples of reporting timelines determined based on a minimum time period implemented by the reporting timeline determination circuitry of FIG. 2, according to some embodiments of the present disclosure.

FIG. 4 is a diagram illustrating examples of reporting timelines determined based on a minimum time period with respect to a Channel State Information (CSI) reference resource implemented by the reporting timeline determination circuitry of FIG. 2, according to some embodiments of the present disclosure.

FIG. 5A is a diagram illustrating an example of a reporting timeline determined based on a maximum reliability time period implemented by the reporting timeline determination circuitry of FIG. 2, according to some embodiments of the present disclosure.

FIG. 5B is a diagram illustrating another example of a reporting timeline determined based on a maximum reliability time period implemented by the reporting timeline determination circuitry of FIG. 2, according to some embodiments of the present disclosure.

FIG. 5C includes diagrams illustrating other examples of reporting timelines determined based on a maximum reliability time period implemented by the reporting timeline determination circuitry of FIG. 2, according to some embodiments of the present disclosure.

FIG. 5D includes a diagram illustrating an example of a timeline determined based on multiple carriers (CC) operation related to UE-initiated beam reporting implemented by the reporting timeline determination circuitry of FIG. 2, according to some embodiments of the present disclosure.

FIG. 6 is a flowchart illustrating a method implementing UE-initiated beam reporting procedures including reporting timeline determination, according to some embodiments of the present disclosure.

FIG. 7 illustrates a system including a UE and a general Nodes B (gNB) in communications with each other.

FIG. 8 is a block diagram of an electronic device implementing measurement gap canceling, including processing time determination, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in some embodiments (e.g., in one or more embodiments). In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In the realm of wireless communication technologies, for example 5G NR, some beam management procedures, including beam reporting, were based on network side configuration and activation. For example, in some legacy 5G NR standards, there can be procedures related to downlink (DL) beam management that may involve the network establishing the DL beams between the gNB and UE which may rely on sweeping different reference signals (RSs) at different stages and reporting the corresponding measurement at some stages; and/or the network maintaining the established beams and call beam failure recovery procedures, if deemed appropriate. These aforementioned beam management procedures, based on network side activation, may require an extensive exchange of communication between the network side (e.g., gNB or base station) and the UE, which may further lead to degraded performance and/or efficiency of wireless communication, for example including relatively large uplink (UL) reporting, control signaling overhead, higher latency, and/or the like. These, and other, challenges related to beam management procedures (based on network side activation) may have motivated the development of User Equipment (UE)-initiated beam reporting procedures (e.g., enabling UE to activate beam reporting) as later the wireless communication technology standards emerged.

As used herein, “User Equipment (UE)-initiated beam reporting” may refer to procedures that can involve the UE activating (e.g., triggering) reporting to the network side (e.g., base station, gNB) regarding the quality of one or more received beams (e.g., transmitted from a gNB), such as the current signal beam(s) and/or the new beam(s). Unlike beam management that can be controlled and/initiated on the network side, the UE-initiated beam reporting may involve the UE having the capability to detect the triggering event(s) to initiate the beam report transmission to the network side, for instance when the current beam quality drops below a certain threshold and/or when a new beam becomes significantly better. Subsequently, in response to the event-triggering, the UE may transmit a beam report containing data relating to beam measurements, such as Level 1 Reference Signal Received Power (L1-RSRP), to ultimately request resources for possibly finding a new, more efficient beam. Thus, UE-initiated beam reporting may lead to more timely beam reports (e.g., based on a real-time detected change in the beam quality), with reduced occurrences of reporting and/or signaling overhead with respect to network side activated beam reporting procedures. Furthermore, implementing UE-initiated beam reporting may improve the overall performance of wireless communication, for example by enabling faster beam switching and/or improving connection stability, especially in dynamic wireless communication environments with high UE mobility.

According to some embodiments, wireless devices can include a UE-initiated beam reporting circuit, including reporting timeline determination circuitry that may be configured to determine a reporting timeline relating to UE-initiated beam reporting procedures and/or to select one or more received beams (e.g., measurements of RSs corresponding to the selected beams) to include in the UE-initiated beam report in a manner that realizes improvements over network side activation of beam reporting, including improving the accuracy and/or reliability (e.g., with respect to temporal considerations) of the information contained in the UE-initiated beam reports (e.g., content), reducing latency associated with the UE-initiated beam reporting transmissions (e.g., inefficient or multiple retransmissions), and/or the like. In some embodiments, the reporting timeline determination functions and/or circuitry may be configured to execute procedures (to support reporting timeline determination) corresponding to UE-initiated beam report transmission procedures in accordance with “Mode A” operations or in accordance with “Mode B” operations.

In some embodiments, the reporting timeline determination functions and/or circuitry may be configured to execute a plurality of procedures to support the functions related to reporting timeline determination to improve UE-initiated beam reporting procedures, as disclosed herein. For example, the reporting timeline determination circuitry may be configured to determine a reporting timeline based on a threshold for a minimum time period using a Channel State Information (CSI) reference resource defined relative to the first symbol on the first uplink channel and/or determine a reporting timeline based on a threshold for a minimum time period using a CSI reference resource defined relative to the first symbol on the second uplink channel. Further, in some embodiments, the reporting timeline determination functions and/or circuitry may be configured to determine a reporting timeline based on a threshold for a minimum time period (Z′_{ref}) (e.g., defined backward relative to the first symbol on the second uplink channel), and/or determine a reporting timeline based on a threshold for a maximum reliability time period (Y) (e.g., defined backward relative to the first symbol on the second uplink channel).

In some embodiments, the reporting timeline determination functions and/or circuitry may be configured to detect the violation(s) of the determined reporting timeline, for example determining one or more beams may be received at time(s) that fail to meet the threshold for the minimum time period (Z′_{ref}) (e.g., beams received during the minimum time window). In some embodiments, the reporting timeline determination functions and/or circuitry may be configured to execute one or more content adjustment functions for the UE-initiated beam report based on detected violation(s) of the determined reporting timeline (e.g., report content dropping, transmission of reserved values, reporting the current beam RSRP measurement and ID, etc.), and/or additional functions as deemed appropriate, thereby improving the accuracy and/or efficiency of UE-initiated beam reporting procedures.

In some embodiments, the reporting timeline determination functions and/or circuitry may be configured to implement UE-initiated beam reporting procedures related to multiple component carrier (CC) operation in manner that may realize various advantages with respect to beam management, such as mitigating the deterioration of a current beam, which may be transmitted within a current CC, by using a new beam that may be transmitted within a new, different CC based on the UE-initiated beam report. For example, a Transmission Configuration Indicator (TCI) state in the current CC may be configured to include an RS of a new beam received within in another new CC.

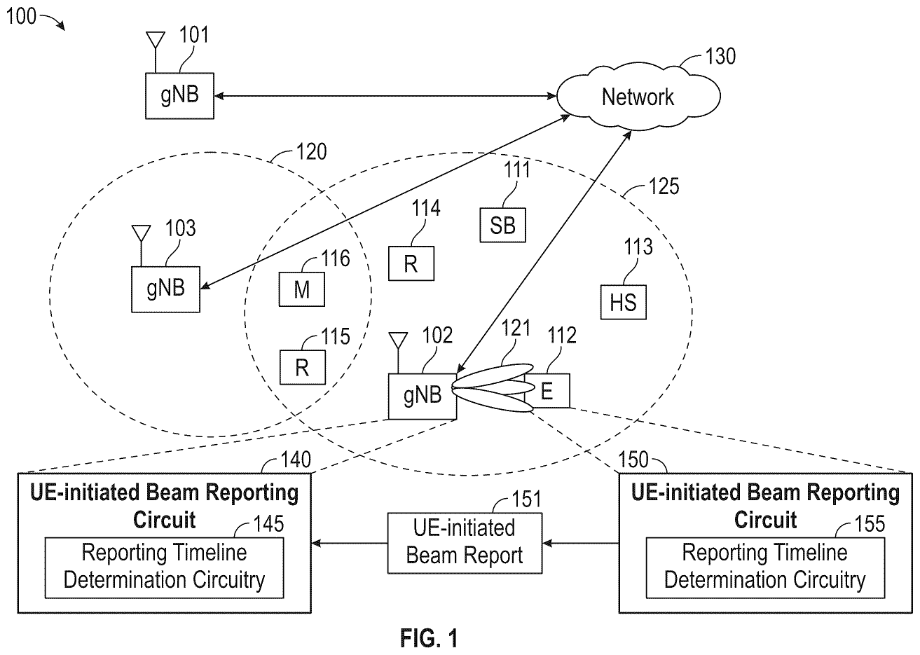

FIG. 1 illustrates an example wireless network system 100 for implementing UE-initiated beam reporting, including reporting timeline determination functions, according to some embodiments of the present disclosure.

As illustrated in FIG. 1, the wireless network system 100 may include multiple base stations (BS), also referred to herein as general Nodes B (gNB), shown as a gNB 101, a gNB 102, and a gNB 103. The gNB 101 may communicate with the gNB 102 and the gNB 103. The gNB 101 may also communicate with at least one network (e.g., an Internet Protocol (IP) network) 130, such as the Internet, a proprietary IP network, or other data network. Instead of gNB, a component may also be referred to herein as an enhanced Node B (eNB). Depending on the network type, other terms can be used instead of gNB or BS, such as “access point” and/or the like. As used herein, “gNB” may refer to a base station (BS) and/or a network infrastructure component that provides wireless access to remote terminals. Also, the wireless network 100 may include multiple wireless communication devices that may be associated with an end user, shown as user equipment (UE) devices 111-116. As used herein, “UE” may refer to remote wireless equipment that wirelessly accesses a gNB. The UE devices 111-116 may be implemented as a mobile device (e.g., a mobile telephone, a smartphone, a cellular device, a cell phone, etc.) and/or a stationary device (e.g., a desktop computer, etc.). Depending on the network type, other terms can be used instead of UE, such as “mobile station,” “subscriber station,” “remote terminal,” “wireless terminal,” or “user device.”

The gNB 102 may provide wireless broadband access to a network 130 for multiple UE devices within a geographical area covered by the gNB 102, shown as cell 120. As used herein a “cell” may refer to a geographical area covered by a single gNB where a UE device can connect to the network. In the example of FIG. 1, the UE devices in cell 120 may be situated in disparate remote locations, and may include a UE device 111, which can be located in a small business (SB); a UE device 112, which can be located in an enterprise (E); a UE device 113, which can be located in a WiFi hotspot (HS); a UE device 114, which can be located in a first residence (R); a UE device 115, which can be located in a second residence (R); and a UE device 116, which can be a mobile device (M) like a cell phone, a wireless laptop, a wireless PDA, and/or the like. The gNB 103 may provide wireless broadband access to the network 130 for multiple UE devices within a cell 125 of the gNB 103. The UE devices in cell 125 may be situated in disparate remote locations and may include the UE device 115 and the UE device 116. In some embodiments, one or more of the gNBs 101-103 can communicate with each other and with the UE devices 111-116 using wireless technologies in accordance with known standards, including but not limited to: 5G NR; long term evolution (LTE) LTE; long term evolution-advanced (LTE-A); WiMAX; and/or other advanced wireless communication techniques.

Dotted lines in FIG. 1 may represent an approximate extent of the cells 120 and 125, which are shown as approximately circular for the purposes of illustration and explanation. For example, the cells (e.g., coverage areas) associated with gNBs 101, 102, 103, such as the cells 120 and 125, can have other shapes, including irregular shapes, depending upon the configuration of the gNBs 101, 102, 103 and variations in the radio environment associated with natural and man-made obstructions. The gNBs 101, 102, 103 may provide wireless access in accordance with one or more wireless communication protocols including but not limited to: 5G; 5G NR; 3GPP NR; LTE; LTE-A; high speed packet access (HSPA), Wi-Fi 802.11a/b/g/n/ac; and/or other advanced wireless communication techniques.

The gNBs 101-103 may implement a transmit (TX) path that is analogous to transmitting in the downlink (DL) to UE devices 111-116 and may implement a receive (RX) path that is analogous to receiving in the uplink (UL) from UE devices 111-116. In an operational example, the gNB 102 may perform DL transmissions to UE devices 111-116 in the coverage area 120. For example, DL transmission from the gNB 102 may involve transmitting data and/or control signals to be received by the UE devices 111-116 over a wireless channel, in accordance with one or more wireless communication protocols. DL communication may be utilized for delivering data and/or control signals from the network side (e.g., gNB) to the UE devices to support several services and/or applications (e.g., browsing Internet content, software updates, streaming services, etc.).

The UE devices 111-116 may implement the TX path for transmitting in the UL to the gNBs 101-103 and may implement the RX path for receiving in the DL from the gNBs 101-103. In another operational example, one or more of the UE devices 111-116 in the coverage area 120 may perform UL transmissions to the gNB 102. As an example, an UL transmission from the UE device 112 may involve transmitting data and/or control signals to be received by the gNB 102 over a wireless channel in accordance with one or more wireless communication protocols. The UL communication may be utilized for transmitting user-generated data (e.g., uploads, voice, sensor data, etc.), for example, and maintaining the connections with the gNBs 101-103 through signaling and feedback.

In some embodiments, one or more of the UE devices 111-116 may include circuitry, programing, and/or a combination thereof for implementing the capabilities and/or functions related to UE-initiated beam reporting, including reporting timeline determination, as disclosed herein. In some embodiments, one or more of the gNBs 101-103 may include circuitry, programing, or a combination thereof for implementing the capabilities and/or functions (e.g., network side operations) related to UE-initiated beam reporting, including reporting timeline determination, as disclosed herein. For example, FIG. 1 illustrates that gNB 102 may implement or include an UE-initiated beam report circuit 140 including reporting time determination circuitry 145, which enables the gNB 102 to execute the capabilities and/or functions for (network side) UE-initiated beam reporting including, for example, configuring one or more thresholds for the UE to utilize for reporting timeline determination, as disclosed in greater detail herein; and the UE device 112 may implement or include an UE-initiated beam reporting circuit 150 including reporting timeline determination circuitry 155, which enables the UE device 112 to execute the capabilities and/or functions for (UE side) UE-initiated beam reporting including, for example, determining a reporting timeline related to UE-initiated beam reporting procedures and/or transmissions, as disclosed in greater detail herein.

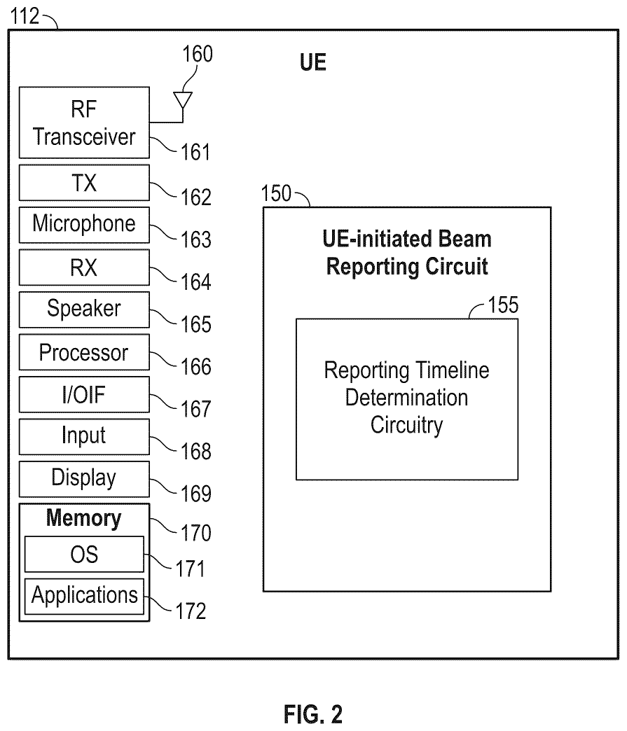

The UE-initiated beam reporting circuits 140, 150 may be configured to execute algorithms, functions, and procedures that may involve the UE 112 communicating to the network, via the gNB 102 for example, information relating to the signal qualities of various transmitted beams, in accordance with a wireless communication technology standard (e.g., 5G NR). In some embodiments, the UE-initiated beam reporting circuits 140, 150 may implement multiple functions to support UE-initiated beam reporting procedures, as disclosed herein, including but not limited to: detecting one or more trigger-events for activating the UE-initiated beam reporting (e.g., detecting event A1/A2, event A3, beam failure recovery (BFR), etc.); performing beam-level measurements (on RSs for the beam) related to the quality of the beams, including Reference Signal Received Power (RSRP), Reference Signal Received Power (RSRQ), Signal-to-Interference-plus-Noise Ratio (SINR), etc.; performing CSI-RS measurements related to beams; generating and/or preparing the information (e.g., content) to be included in a UE-initiated beam report; performing functions of UE-initiated beam reporting transmission procedures based on “Mode A” operation or “Mode B” operation (described in greater detail in reference to FIG. 2); and/or the like.

In an operational example, the gNB 102 may periodically transmit multiple RSs (as bursts) in different directions by sweeping one or more beams (e.g., approximately 8 beams) across the coverage area, where beam sweeping can be a process for initial access and connection maintenance for the UEs 111-116 within the wireless network system 100, in accordance with some wireless communication technology standards (e.g., 5G NR). The beams transmitted from the gNB 102 may contain RSs that allow the UE 112 to select a signal from the received beams and align with the network. In some embodiments, the RSs may be transmitted as Synchronization Signal Blocks (SSBs) for initial access and/or connection. For instance, the UE 112 may identify the SSB with the strongest signal (e.g., highest RSRP) and use its corresponding beam for initial access. After the initial connection is established, the UE 112 may be connected and engaged in a data session, the beams can be further refined, and other reference signals may be used. The gNB 102 may continue to periodically transmit bursts of beams, such as beams 121 (e.g., sweeping beams), for various beam management related functions, such as continuously improving (or optimizing) the beam alignment, beam refinement, and tracking movement of the UE 112. The beams 121 transmitted by the gNB 102 after the initial connection is established may be relatively narrower (than the beams transmitted for initial access), for instance one or more of the beams 121 may include RSs such as CSI-RS.

In some embodiments, the UE 112 may be configured to measure the RSs for each of the beams 121 received by the UE 112, such as a current serving beam (e.g., beam that the UE is currently using for data reception and transmission) and additional beams (e.g., alternative or potential new beams) which can be transmitted from the gNB 102 (e.g., DL TX) for further beam refinement during the connection. As a function of UE-initiated beam reporting, the UE 112 may have the capability to detect a trigger-event with respect to the received beams 121. For example, the UE-initiated beam reporting circuit 150 may be configured to detect that a signal power (e.g., RSRP) of one of the received beams 121 has suddenly dropped due to interference, becoming less than a configured threshold and indicating that a triggering-event (with respect to activating the UE-initiated beam reporting procedures) may have been encountered. Thus, the UE 112 may activate the UE-initiated beam reporting procedures to generate and/or transmit the UE-initiated beam report 151 in response to detecting the event-trigger(s), and may ensure that the UE-initiated beam report 151 (and corresponding beam measurements) can be generated closer to a time when evaluating beam quality may be most needed (e.g., when changing network conditions and events, such as mobility and interference, may impact beams), rather than beam reporting being based on older and/or pre-scheduled beam measurements (e.g., on the network side). In some embodiments, the UE-initiated beam report 151 may include information that can be conveyed to the gNB 102, such as, but not limited to: event-trigger identity (e.g., neighbor beam better than current beam); beam measurements of one or more received beams (RSRP, RSRQ, SINR, etc.); beam identifier (ID)/index; UE capabilities; and/or the like.

In the example of FIG. 1, the UE-initiated beam reporting circuit 150 of the UE 112 may be configured to implement UE-initiated beam report transmission procedures in accordance with “Mode A” operations, as described in greater detail in reference to FIG. 2. When the UE 112 has been triggered to generate and/or send the UE-initiated beam report 151, the UE-initiated beam reporting circuit 150 may be configured to transmit a short message on a first UL channel, such as a Physical Uplink Control Channel (PUCCH), to initially notify the gNB 112. In response, the UE-initiated beam report circuit 140 of the gNB 102 may be configured to decode the PUCCH message and then send a Downlink Control Information (DCI) message (also referred to herein as the “DCI”) to the UE 112. The DCI may include information to grant a resource on a different, second uplink UL channel for transmission of the UE-initiated report 151. For example, the DCI received by the UE 112 may indicate the specific radio resources for the second UL channel that the UE 112 can utilize for transmitting the UE-initiated beam report 151 to the gNB 102. Ultimately, the UE-initiated beam report 151 may be transmitted by the UE-initiated beam reporting circuit 150 of the UE 112 over the allocated second UL channel, which may be a Physical Uplink Shared Channel (PUSCH).

During operation, there may be several temporal (e.g., time based) considerations that may be related to the UE 112 executing the UE-initiated beam reporting procedures. For example, there may be a required amount of time needed for the UE 112 to perform several functions in order to obtain the real-time measurements of RSs for the received beams 121. Additionally, there may be an amount of time required for the UE 112 to receive and/or process information that may be pertinent to properly executing the UE-initiated beam reporting procedures (e.g., receiving and decoding a DCI message from the gNb 102 to indicate a resource for a second UL channel to carry beam report). If there is not enough time to appropriately obtain the beam measurements of a latest beam (e.g., the beam most recently received by the UE 112) of the beams 121 and/or not enough time to process the information for proper transmission of the UE-initiated beam report 151, before the time when the UE-initiated beam report is transmitted, there may be a possibility of inaccurate data and/or missing data from the UE-initiated beam report (transmitted to the gNB 102), or even a failure to transmit the UE-initiated beam report 151 to the gNB 102, which may further cause inefficiencies, unexpected behaviors, and/or errors in the beam management functions (e.g., selecting a beam based on inaccurate beam measurement information).

Additionally, there may be other temporal considerations that may be related to the UE 112 executing the UE-initiated beam reporting procedures with respect to the reliability of the information (e.g., content) included in the UE-initiated beam report 151. For example, measuring one or more of the beams 121 that may be received at times too far in advance from the transmission of the UE-initiated beam report 151 may cause issues with the reliability of a UE-initiated beam report 151, for example in wireless networks operating at higher frequencies and operational environment associated with relative high mobility (e.g., frequent movement of the UEs 111-116). The radio channel conditions in these scenarios may change rapidly, making the previously collected measurement data for previously received beams obsolete by the time the UE-initiated beam report 151 may be sent. In wireless networks utilizing higher frequencies, the environment may be highly susceptible to fast and significant changes. User movement, device rotation, or new physical obstructions can quickly block the Line-of-Sight (LoS) path to a current best beam, degrading its quality. If the UE 112 takes measurements of the RSs for a beam that is received well before the time of transmitting the UE-initiated beam report 151, those measurements may no longer reflect the true channel conditions at a time when the UE-initiated beam report 151 may be received and/or processed by the UE-initiated beam reporting circuit 140 of the gNB 102. If the reliability of the UE-initiated beam report 151 has been reduced and/or compromised, it may lead to degraded performance of one or more other beam management functions that may utilize the information provided in the beam reporting. For example, the gNB 102 may uses the UE-initiated beam report 151 to select a best beam for communication with the UE 112. If the UE-initiated beam report 151 contains outdated information, there is a possibility that the gNB 102 can select a beam that is no longer optimal. This “erroneous beam selection” may further lead to a beam failure, or even an overall performance degradation of the wireless network system 100.

As used herein, a “reporting timeline determination” may refer to several algorithms, procedures, and/or calculations that may be related to analyzing the aforementioned temporal considerations of UE-initiated beam reporting procedures. For example, the reporting timeline determination circuitry 145, 155 may be configured to implement a minimum time period (Z′_{ref}), which can indicate a minimum amount of time that is required between the time of the start of the second UL channel (for transmitting the UE-initiated beam report 151) and the time of the end of a latest beam (e.g., most recently received beam from the received beams 121) that may be selected to have its corresponding beam measurements (e.g., measurements of RSs for the beam) included in the UE-initiated beam report 151 (e.g., considering the processing related timing). Also, the reporting timeline determination circuitry 145, 155 may be configured to implement a maximum reliability time period (Y), which can indicate a maximum amount of time between the start of the second UL channel (for transmitting the UE-initiated beam report 151) to the end of an earliest beam (e.g., most priorly received beam of the received beams 121) that may be selected to have its corresponding beam measurements (e.g., measurements of RSs for the beam) included in the UE-initiated beam report 151 (e.g., considering the content reliability timing).

In some embodiments, the reporting timeline determination circuitry 145, 155 may implement one or more reporting timeline determination functions that may include, but are not limited to: obtaining a time corresponding to a trigger-event for UE-initiated beam reporting; obtaining the times of one or more beams (e.g., or resources used for the beams) received at the UE (e.g., from a gNB) relating to the UE-initiated beam reporting procedures (e.g., times of beams received related to the triggering-event and/or times of beams received during a time window for obtaining beam measurements for a triggered UE-initiated beam report); obtaining a time relating to the occurrence of the first UL channel for the particular UE-initiated beam reporting procedures; obtaining a time relating to the occurrence of the second UL channel for the particular UE-initiated beam reporting procedures; calculating time window(s) associated with thresholds with respect to any of the aforementioned times (e.g., times for trigger-event, times for received beams, times for UL channels, etc.); executing UE-initiated beam reporting procedures based on multiple component carrier (CC) operations; and/or the like.

In some embodiments, the reporting timeline determination circuitry 145, 155 may be configured to dynamically perform reporting timeline determination at any time before the start of the UE-initiated beam report transmission, for example concurrently while the beams 121 are being received by the UE 112 for subsequent reporting, or after the beams 121 have been received by the UE 112 for reporting. Also, the reporting timeline circuitry 145, 155 may be configured to dynamically perform reporting timeline determination using received time information (e.g., configured by the network) and/or UE-configured time information associated with the particular UE-initiated beam reporting procedure that is utilized by the UE 112 (e.g., Mode A or Mode B). For example, the UE 112 may receive time information from the network (e.g., DCI transmitted from the gNB 102) regarding dynamically scheduled resources used for the second UL channels, or the UE 112 may select pre-configured resources (including times related to providing the resources) used for UL channels. The functions implemented by the reporting timeline circuitry 140, 150 and the reporting timeline circuitry 145, 155 to execute the reporting timeline determination aspects of UE-initiated beam reporting, as disclosed herein, are described in greater detail in reference to FIG. 2-FIG. 5C.

Referring back to the example of FIG. 1, the reporting timeline determination circuitry 155 of the UE 112 may be configured to dynamically calculate a timeline relating to the UE-initiated beam reporting procedures, for example including the times corresponding to the received beams 121, and a time corresponding to the start of the second UL channel (or resources) for transmitting the UE-initiated beam report 151. The reporting timeline may also include a time window representing the threshold for the minimum time period (Z′_{ref}) (calculated backward relative from the known time of start for the second UL channel). If a beam from beams 121 is received at a time within the time window based on the calculated reporting timeline, that beam may be considered to fail satisfying the threshold for the minimum time period (Z′_{ref}) and thus may not be selected to have its corresponding beam measurements included in the UE-initiated beam report 151 (e.g., considering the processing related timing). Alternatively, for one or more of the beams 121 that may be received before the time window (based on the calculated reporting timeline), those beams may be considered to meet the threshold for the minimum time period (Z′_{ref}), and thus can be selected to have their corresponding beam measurements included in the UE-initiated beam report 151.

In some embodiments, the UE-initiated beam reporting circuits 140, 150 may be configured to implement other function that may be related to Radio Resource Management (RRM) for the wireless network system 100, in accordance with some wireless communication technology standards (e.g., 5G NR). As an example, RRM related functions, such as a handover procedure between the UE 112 and the gNB 102, may include UE measurement configuration and reporting. For example, RRM related measurements, such as signal quality of cells, may be utilized in determining a target cell that is optimal and/or suitable for handover. In some embodiments, measurement configuration and reporting during the handover procedure may be set for the UE 112 to perform and/or obtain actual (e.g., real-time) measurements (e.g., RSRP, etc.) of resources (e.g., cells, beams, frequencies, etc.). For example, the handover procedure may utilize reoccurring measurements obtained (e.g., performing real-time measuring) by the UE 112 of the signal quality of source cell and neighboring cells.

FIG. 2 is a block diagram illustrating an example UE for UE-initiated beam reporting including reporting timeline determination, implementing a beam reporting circuit 150 and reporting timeline determination circuitry 155, according to some embodiments of the present disclosure.

As illustrated in FIG. 2, an example configuration of the UE 112 (e.g., see FIG. 1) may include multiple hardware and/or software components implementing capabilities related to UE-initiated beam reporting including reporting timeline determination. The UE 112 depicted in FIG. 2 is not intended to be limiting, and the related structure and/or functions of the component may be implemented in a wide variety of configurations, without departing from the scope of this disclosure. In some embodiments, the UE 112 may implement the functions related to UE-initiated beam reporting that are performed on the UE side, as disclosed herein.

Additionally, in some embodiments, a gNB (e.g., gNB 102 shown in FIG. 1) may be configured with similar hardware and/or software components to implement the capabilities related to UE-initiated beam reporting including reporting timeline determination, as described herein with reference to FIG. 2. In some embodiments, the gNB may implement the functions related to UE-initiated beam reporting that are performed on the network side, as disclosed herein.

As shown in FIG. 2, the UE 112 may include an antenna 160, a radio frequency (RF) transceiver 161, TX processing circuitry 162, a microphone 163, and RX processing circuitry 164. The UE 112 may also include a speaker 165, a processor 166, an input/output (I/O) interface (IF) 167, an input device 168, a display 169, and a memory 170. The memory 170 may include an operating system (OS) 171 and one or more applications 172.

The RF transceiver 161 may receive from the antenna 160, an incoming RF signal transmitted by a gNB (e.g., gNB 102 in FIG. 1) of the network 100. The RF transceiver 161 may down-convert the incoming RF signal to generate an intermediate frequency (IF) or baseband signal. The IF or baseband signal can be sent to the RX processing circuitry 164, which may generate a processed baseband signal by filtering, decoding, and/or digitizing the baseband or IF signal. The RX processing circuitry 164 may transmit the processed baseband signal to the speaker 165 (such as for voice data) or to the processor 166 for further processing (such as for web browsing data).

The TX processing circuitry 162 may receive analog or digital voice data from the microphone 163 or other outgoing baseband data (such as web data, e-mail, or interactive video game data) from the processor 166. The TX processing circuitry 162 may encode, multiplexes, and/or digitizes the outgoing baseband data to generate a processed baseband or IF signal. The RF transceiver 161 may receive the outgoing processed baseband or IF signal from the TX processing circuitry 162 and can up-convert the baseband or IF signal to an RF signal that is transmitted via the antenna 160.

The processor 166 may include one or more processors or other processing devices, and may execute the OS 171 stored in the memory 170 in order to control the overall operation of the UE 112. For example, the processor 166 may control the reception of forward channel signals, and the transmission of reverse channel signals by the RF transceiver 161, the RX processing circuitry 164, and the TX processing circuitry 162. In some embodiments, the processor 166 may include at least one microprocessor or microcontroller.

The processor 166 may also be capable of executing other processes and programs resident in the memory 170 and the beam reporting circuit 150, such as processes for UE-initiated beam reporting including reporting timeline determination. The processor 166 may move data into or out of the memory 170 as required by an executing process.

In some embodiments, the processor 166 may execute the applications 172 based on the OS 171 or in response to signals received from gNBs or an operator. The processor 166 may also be coupled to the I/O interface 167, which provides the UE 112 with the ability to connect to other devices, such as laptop computers and handheld computers. The I/O interface 167 may provide the communication path between these accessories and the processor 166.

The processor 166 may also be coupled to the input device 168 and the display 169. The operator of the UE 112 may use the input device 168 to enter data into the UE 112. The input device 168 may be a keyboard, touchscreen, mouse, track ball, voice input, or other device capable of acting as a user interface to allow a user in interact with the UE 112. For example, the input device 168 may include voice recognition processing, thereby allowing a user to input a voice command. In another example, the input device 168 may include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 166 may also be coupled to the display 169. The display 169 may be a liquid crystal display, a light emitting diode (led) display, an organic light emitting diode (OLED) display, a micro led display, a nano led display, or any other suitable display capable of rendering text and/or at least limited graphics, such as from web sites.

The memory 170 may be coupled to the processor 166. Part of the memory 170 may include a random-access memory (RAM), and another part of the memory 170 may include a Flash memory or other read-only memory (ROM). In some embodiments, the memory 170 may store data (e.g., minimum time period Z′_{ref}, maximum reliability time period Y, additional reporting timeline determination parameters, etc.) associated with functions for UE-initiated beam reporting including reporting timeline determination, as disclosed herein. In some embodiments, the memory 170 may store data and/or instructions utilized by the beam reporting circuit 150 and reporting timeline determination circuitry 155.

In some embodiments, the beam reporting circuit 150 may be configured to implement multiple functions related to UE-initiated beam reporting, including reporting timeline determination, as disclosed herein. The beam reporting circuit 150 may be configured to implement UE-initiated beam report transmission procedures for UE-initiated beam reporting, for example based on two modes of operations referred to herein as “Mode A” operations that can support dynamically scheduling Uplink Control Information (UCI) by the gNB, and “Mode B” operations that can support UCI in pre-configured resource(s) for a second UL channel. In some embodiments, the beam reporting circuit 150 may be configured such that the UE 112 implements UE-initiated beam reporting using “Mode A” operations, “Mode B” operations, or both operational modes.

In accordance with the “Mode A” operations, the beam reporting circuit 150 can perform beam report transmission procedures that may include: 1) the UE transmitting a first PUCCH (one-bit/multi-bit) (e.g., first UL channel) to request a resource for a second UL channel to carry the beam report; 2) the UE detecting the DCI format to indicate a resource for the second UL channel to carry the beam report, wherein the DCI format may be an UL-grant DCI format; and 3) the UE transmitting the beam report in second UL channel, where the second UL channel may be implemented as a PUSCH. In some embodiments, the UCI may include relevant details regarding the second UL channel (e.g., whether the second UL channel is PUCCH, PUSCH or both). In some embodiments, the request format may be a scheduling request (SR) or a new UCI type. Additionally, in some embodiments, the first channel may be implemented as a periodic PUCCH resource with PUCCH format that is configured by dedicated RRC signaling.

In accordance with the “Mode B” operations, the beam reporting circuit 150 can perform beam report transmission procedures that may include: 1) the UE transmitting a first PUCCH (one-bit/multi-bit) (e.g., first UL channel) notifying a second UL channel to carry beam report; and 2) the UE transmitting the beam report in the second UL channel, where the second UL channel may be implemented as pre-configured resource(s), such as a type 1 Configured Grant-Physical Uplink Shared Channel (CG-PUSCH). In some embodiments, the UCI may include relevant details regarding the second UL channel (e.g., whether the second UL channel is PUCCH, PUSCH or both). In some embodiments, the request format may be a scheduling request (SR) or a new UCI type. Further, in some embodiments, the notification from the UE may be transmitted in a separate reporting instance from the beam report. Additionally, in some embodiments, the first UL channel may be implemented as a periodic PUCCH resource with PUCCH format that is configured by dedicated RRC signaling.

The beam reporting circuit 150 may be configured to implement other functions related to UE-initiated beam reporting including: monitoring and/or measuring the quality of the reference signal associated with a beam, using metrics such as Reference Signal Received Power (RSRP); detecting and/or initiating event-driven trigger, initiating the UE-initiated beam reporting procedure; obtaining and/or analyzing information related to the quality of the of the reference signal associated with a beam; and/or the like.

Due to the different beam report transmission procedures that may be executed based on whether the UE 112 is configured to execute “Mode A” operations or the “Mode B” operations, different criteria may be utilized to determine the reporting timeline. For example, in high mobility scenarios, it may be possible that from the time that UE 112 transmits the first UL channel as an UL resource request (in “Mode A”) or as a notification of an upcoming second UL channel (in “Mode B”) the event may no longer be valid and/or the content of UE-initiated beam report may need to been changed (e.g., reported measurements based on more recent resources). Accordingly, the reporting timeline determination circuitry 155 may be configured to execute one or more different procedures for determining a reporting timeline to accommodate a wide-range of real-world scenarios and configurations for the UE 112 in a manner that may mitigate transmitting inaccurate and/or outdated information in the UE-initiated beam report to the gNB and/or mitigate triggered retransmissions of second UL channel. Further, the reporting timeline determination circuitry 155 may be configured to utilize various temporal considerations, requirements, and/or restrictions in determining a “timeline” that can be related to UE-initiated beam reporting, including but not limited to: time requirements for obtaining beam measurements of current and/or new resources; the latest occurrence of a resource (most recently occurring with respect to the second UL channel) that may have measurements included in the UE-initiated beam report; the earliest occasion of a resource (most previously occurring with respect to the second UL channel) that may have measurements included in the UE-initiated beam report; time restrictions to mitigate blind decoding at gNB; time requirements for transmitting and decoding notifications and/or requests for second UL channel; time requirements related to UE processing (e.g., processing delay); and/or the like.

The reporting timeline determination circuitry 155 may be configured to implement different procedures for determining a corresponding reporting timeline with respect to whether “Mode A” operations or the “Mode B” operation are being performed to support beam report transmission procedures. Thus, the reporting timeline determination circuitry 155 may implement a reporting timeline determination procedure that may be deemed appropriate and/or optimal in order to support reliable and valid content that is transmitted in the UE-initiated beam report based on the configurations (e.g., “Mode A” or the “Mode B”).

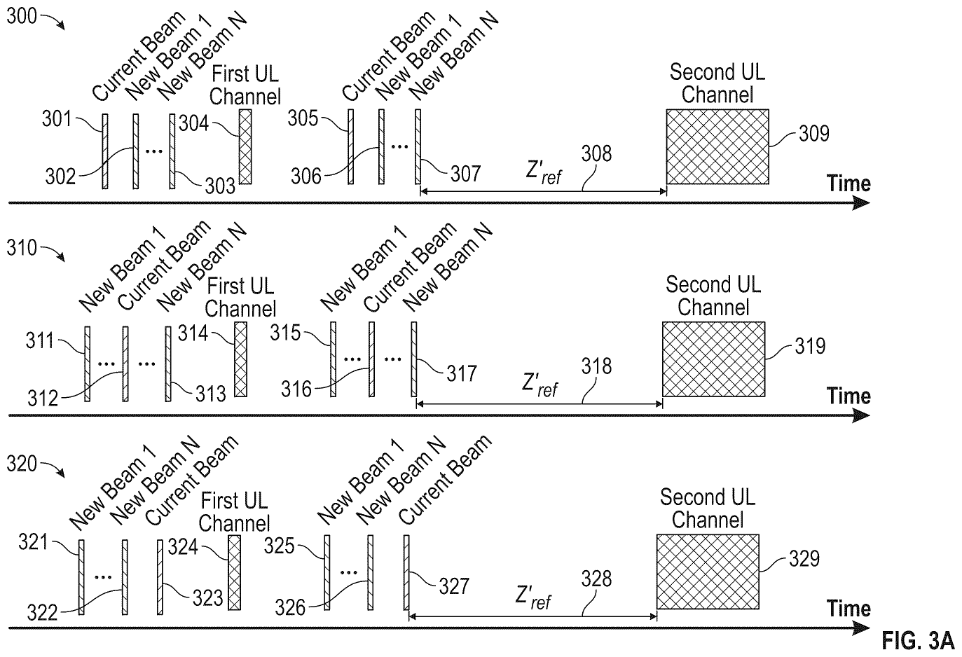

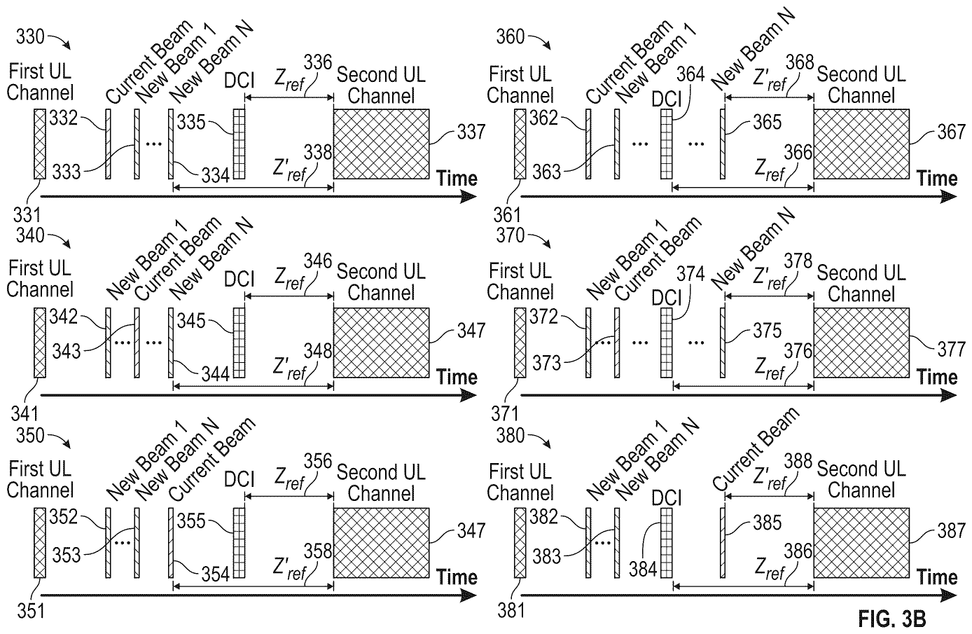

The reporting timeline determination circuitry 155 may be configured to execute a plurality of procedures to support the functions related to reporting timeline determination, as disclosed herein. For example, the reporting timeline determination circuitry 155 may implement: determining a reporting timeline based on a threshold for a minimum time period using a CSI reference resource defined relative to the first symbol on the first uplink channel; determining a reporting timeline based on a threshold for a minimum time period using a CSI reference resource defined relative to the first symbol on the second uplink channel; determining a reporting timeline based on a threshold for a minimum time period (e.g., defined backward relative to the first symbol on the second uplink channel); determining a reporting timeline based on a threshold for a maximum reliability time period (e.g., defined backward relative to the first symbol on the second uplink channel); detecting violation(s) of the determined reporting timeline; selecting one or more received beams (e.g., measurements of RSs corresponding to the selected beams) to include in the UE-initiated beam report; executing one or more content adjustment functions for the UE-initiated beam report based on detected violation(s) of the determined reporting timeline (e.g., report content dropping, transmission of reserved values, reporting the current beam RSRP measurement and ID, etc.); executing UE-initiated beam reporting procedures based on multiple CC operations; and/or additional functions as deemed appropriate. Examples of the different procedures that may be implemented by the reporting timeline determination circuitry 155 to support the functions relating to UE-initiated beam reporting, including reporting timeline determination, are described in greater detail below in reference to FIG. 3A-FIG. 5C, for example.

FIG. 3A includes a diagrams illustrating examples of reporting timelines that may be determined using procedures based on a configured minimum time period (e.g., time window), according to some embodiments of the present disclosure.

In the examples of FIG. 3A, a UE (e.g., UE device 112 in FIG. 1) may be configured for implementing UE-initiated beam reporting. Further, the reporting timeline determination circuitry (e.g., reporting timeline determination circuitry 155 in FIG. 2) of the UE may be configured to determine the reporting timelines 300, 310, and 320 depicted in FIG. 3A with respect to the UE being configured to implement “Mode B” operations for the UE-initiated beam report transmission procedures. There may be various temporal considerations related to UE-initiated beam reporting, for instance considering a time period (or timeline) that occurs between a latest occasion of a resource (most recent resource having measurements that are included in the UE-initiated beam report) and the transmission of the UE-initiated beam report. For example, during operation, there may be a time period that is associated with performing the real-time beam measurements of RSs for beams, and processing information that may be pertinent to properly executing the UE-initiated beam reporting procedures (e.g., decoding the DCI to indicate a resource for a second UL channel to carry beam report). If there is not enough time to appropriately and/or accurately obtain the beam measurements of the latest resource before the UE-initiated beam report is transmitted, there may be a higher likelihood of inaccurate data and/or missing data from the UE-initiated beam report (transmitted to the gNB) which may further cause inefficiencies, unexpected behaviors, and/or errors in the beam management functions (e.g., selecting a beam based on inaccurate beam measurement information).

Accordingly, FIG. 3A illustrates reporting timelines 300, 310, and 320 that may be determined for UE-initiating beam reporting that is based on a minimum time period “Z′_{ref}”. As used herein, the term “Z′_{ref}” may refer to a minimum time period that is defined between a last symbol carrying the latest occasion of a resource (that is measured) and a first symbol of the UE-initiated beam report. In some embodiments, the minimum time period (Z′_{ref}) may be statically configured (e.g., pre-defined by the UE and/or gNB, etc.), dynamically configured (e.g., indicated to the UE, based on the conditions of the network, etc.), and/or semi-statistically configured. In some embodiments, the minimum time period (Z′_{ref}) may be derived based on capabilities of the UE (e.g., indicated via capability signaling), and therefore can be reported by the UE to gNB.

In FIG. 3A, the reporting timelines 300, 310, and 320 may involve obtaining and/or reporting measurements for a current beam, and one or more new beams (e.g., additional beams). As used herein “current beam” may refer to a beam (e.g., DL transmission) the UE may be currently using for communication (e.g., to transmit and receive data). As used herein, the term “new beam” may refer to one or more potential alternative beams, for example beams that may a higher reported signal quality (e.g., L1-RSRP) and may be selected to improve communication reliability and throughput. As an example, the UE may obtain beam measurements on the current beam and the new beams that may be included in the UE-initiated beam report, where if a new beam is determined to have a highest signal quality by the UE and/or the gNB (e.g., a highest L1-RSRP), the gNB may then switch its transmission to that new beam.

In FIG. 3A, the reporting timeline 300 may include a current beam 301, a first new beam 302, and an “Nth” new beam 303 (e.g., in N total number of new beams) that are received at times before the first UL channel 304 (e.g., including notification of a second UL channel to carry UE-initiating beam report) is configured for the UE. The reporting timeline 300 may also include a current beam 305, a first new beam 306, and an Nth new beam 307 that occur at times after the first UL channel 304 (e.g., including notification of a second UL channel to carry UE-initiating beam report) is configured for the UE. Accordingly, the minimum time period (Z′_{ref}) may defined as the minimum amount of time that may be required between a last symbol of the latest resource and a first symbol of the UE-initiated beam report that may be transmitted using the second UL channel 309. Thus, the minimum time period (Z′_{ref}) may be used to determine a time window 308 that is backward relative to the time at the start of the second uplink channel 309 (e.g., the first symbol), and a time at the end of a latest resource (e.g., last symbol) to have its beam measurements included in the UE-initiated beam report may be required to occur before this time window 308. In some embodiments, the time window 308 may be determined based on the configured minimum time period (Z′_{ref}) and the time of a pre-configured resource to be used for the second UL channel 309, which therefore may be utilized for the determination of the reporting timeline 300 (including the selected latest resource). In the example, the Nth new beam 307 may be the latest resource that occurs before the tine window 308, including the minimum time period (Z′_{ref}) from the start of the second UL channel 307 and thus it may be considered to satisfy the minimum time period (Z′_{ref}) which indicates that there is suitable amount of time to appropriately obtain its beam measurements and/or process the data for including in the UE-initiated beam report.

In some embodiments, the reporting timeline determination circuitry (e.g., reporting timeline determination circuitry 155 in FIG. 2) may be configured to adjust the selection of the latest resource in the determined reporting timeline 300 such that the minimum time period (Z′_{ref}) is satisfied. For example, the UE is not required to update the UE-initiated beam report content to include beam measurement corresponding to resources that may occur within the time window 308, defined by minimum time period (Z′_{ref}), prior to the start of the second UL channel 309. If there was a scenario where another resource occurred at a time within the time window 308 (e.g., after the Nth new beam 307 and before the start of the second UL channel 309) the UE may determine that a violation(s) of the reporting timeline 300 has been detected (e.g., resource does not satisfy the minimum time period (Z′_{ref}), and therefore the UE may adjust its operation in order to override (e.g., ignore or cancel) performing the beam measurement functions and/or override the inclusion of the corresponding beam measurements in the transmitted UE-initiated beam report.

In some embodiments, the reporting timeline determination circuitry (e.g., reporting timeline determination circuitry 155 in FIG. 2) may be configured to execute one or more functions based on the determined reporting timeline 300 and/or the minimum time period (Z′_{ref}), in addition to and/or in lieu of adjusting the selection of the latest resource. The additional functions that may be performed (e.g., based on the minimum time period (Z′_{ref}) not being satisfied), can include, but are not limited to: adjusting the selected pre-configured resource for transmitting the UE-initiated beam report; report content dropping, transmission of reserved values, reporting only the beam measurement and ID of the current beam; and/or other additional functions as deemed appropriate.

In FIG. 3A, the reporting timeline 310 may include a first new beam 311, a current beam 312, and an Nth new beam 313 that occur at times (e.g., received) before the first UL channel 314 is configured for the UE. The reporting timeline 310 may also include a first new beam 315, a current beam 316, and an Nth new beam 317 that occur at times after the first UL channel 314 is configured for the UE. The minimum time period (Z′_{ref}) may be used to determine a time window 318 that is backward relative to the time at the start of the second uplink channel 319 (e.g., the first symbol). The time at the end of the latest resource (e.g., last symbol) to have its beam measurements included in the UE-initiated beam report may be required to occur before this time window 308. In the determined reporting timeline 310, the Nth new beam 317 may be the latest resource that occurs before the time window 318, including the minimum time period (Z′_{ref}) from the start of the second UL channel 319 and thus it may be considered to satisfy the minimum time period (Z′_{ref}). Accordingly, the reporting timeline determination circuitry (e.g., reporting timeline determination circuitry 155 in FIG. 2) of the UE may select the Nth new beam 317 as the latest resource for UE-initiated beam reporting based on the determine reporting timeline 310.

In FIG. 3A, the reporting timeline 320 may include a first new beam 321, and an Nth new beam 322, and a current beam 323 that occur at times before the first UL channel 324 is configured for the UE. The reporting timeline 320 may also include a first new beam 325, and an Nth new beam 326, and a current beam 327 that occur at times after the first UL channel 324 is configured for the UE. The minimum time period (Z′_{ref}) may be used to determine a time window 328 that is backward relative to the time at the start of the second uplink channel 329 (e.g., the first symbol). The time at the end of the latest resource (e.g., last symbol) to have its beam measurements included in the UE-initiated beam report may be required to occur before this time window 328. In the determined reporting timeline 320, the current beam 327 may be the latest resource that occurs before the time window 328, including the minimum time period (Z′_{ref}) from the start of the second UL channel 329 and thus it may be considered to satisfy the minimum time period (Z′_{ref}). Accordingly, the reporting timeline determination circuitry (e.g., reporting timeline determination circuitry 155 in FIG. 2) of the UE may select the current beam 327 as the latest resource for UE-initiated beam reporting based on the determine reporting timeline 320.

FIG. 3B includes diagrams depicting examples of reporting timelines that may be determined using procedures based on a configured minimum time period (e.g., time window), according to some embodiments of the present disclosure.

In the examples of FIG. 3B a UE (e.g., UE device 112 in FIG. 1) may be configured for implementing UE-initiated beam reporting. Further, the reporting timeline determination circuitry (e.g., reporting timeline determination circuitry 155 in FIG. 2) of the UE may be configured to determine the reporting timelines 330, 340, 350, 360, 370, and 380 depicted in FIG. 3A with respect to the UE being configured to implement “Mode A” operations for the UE-initiated beam report transmission procedures. There may be various temporal considerations related to UE-initiated beam reporting with respect to “Mode A”, for instance considering a time period (or timeline) that may occur between the last symbol of the PDCCH triggering the UE-initiated beam reporting (e.g., end of the DCI) and the first symbol of PUSCH for a second UL channel to carry the UE-initiated beam report (e.g., start of the second UL channel). For example, during operation, there may be an amount of time that is associated with the UE performing PDCCH detection and decoding for receiving the triggering DCI (from the gNB). If there is not enough time to appropriately and/or accurately receive and/or process the DCI (and related information) prior to attempting to transmit the UE-initiated report, there may be related errors, unexpected behaviors, and/or inefficiencies that can negatively impact the UE-initiated beam report transmission procedure, for instance a failure to indicate to the UE which resource is to be used for a second UL channel to carry the UE-initiated beam report.

Accordingly, FIG. 3B illustrates reporting timelines 330, 340, 350, 360, 370, and 380 that may be determined for UE-initiating beam reporting that is based on a minimum time period “Z_{ref}”. As used herein, the term “Z_{ref}” may refer to a minimum time period between the last symbol of the PDCCH triggering the UE-initiated beam reporting (e.g., end of the DCI) and the first symbol of PUSCH for a second UL channel to carry the UE-initiated beam report (e.g., start of the second UL channel). In some embodiments, the minimum time period (Z_{ref}) may be statically configured (e.g., pre-defined by the UE and/or gNB, etc.), dynamically configured (e.g., indicated to the UE, based on the conditions of the network, etc.), and/or semi-statistically configured (e.g., based at least partially on a defined parameter/value). In some embodiments, the minimum time period (Z_{ref}) may be derived based on capabilities of the UE (e.g., indicated via capability signaling), and therefore can be reported by the UE to gNB. Also, in some embodiments, the reporting timeline determination circuitry (e.g., reporting timeline determination circuitry 155 in FIG. 2) of the UE may be configured to determine the reporting timelines 330, 340, 350, 360, 370, and 380 utilizing both the minimum time period (Z_{ref}) and the minimum time period (Z′_{ref}) described in detail in reference to FIG. 3A.

In FIG. 3B, the reporting timeline 330 may include a current beam 332, a first new beam 333, and an Nth new beam 334 that occur at times after the first UL channel 331 (e.g., including the request of a resource for a second UL channel to carry UE-initiating beam report) is configured for the UE. The reporting timeline 330 may also include a DCI 335 (e.g., to indicate a resource for the second UL channel to carry UE-initiated beam report), for example in response to the request from the UE transmitted in the first UL channel 331. The reporting timeline 330 may also include the second UL channel 337 for transmitting the UE-initiated beam reporting from the UE (to the gNB).

Accordingly, the minimum time period (Z_{ref}) may be defined as the minimum amount of time that may be required between the time at the end of the DCI 335 (e.g., last symbol of the PDCCH triggering the UE-initiated beam reporting, start of the second UL channel) and time at the start of the second UL channel 337 (e.g., the first symbol of PUSCH for a second UL channel to carry the UE-initiated beam report). Therefore, the minimum time period (Z_{ref}) may be used to determine a time window 336 that is backward relative to the time at the start of the second uplink channel 337 (e.g., the first symbol), and a time at the end of the DCI 335 (e.g., last symbol). In some embodiments, the time window 336 may be dynamically determined during operation and based on the configured minimum time period (Z_{ref}), the time of the DCI 335, and the time of the indicated resource to be used for the second UL channel 337, which therefore may be utilized for the determination of the reporting timeline 330 (including the selected latest resource). In the described example, the Nth new beam 334 may be the latest resource that occurs before the time window 336, including the minimum time period (Z_{ref}) between the end of the DCI 335 and the start of the second UL channel 337 and thus it may be considered to satisfy the minimum time period (Z_{ref}) which indicates that there is suitable amount of time to appropriately process the DCI for triggering and/or scheduling the UE-initiated beam report.

In some embodiments, the reporting timeline determination circuitry (e.g., reporting timeline determination circuitry 155 in FIG. 2) may be configured to adjust the selection of the latest resource in the determined reporting timeline 300 such that the minimum time period (Z_{ref}) is satisfied and a time window 338 including the minimum time period (Z′_{ref}) is satisfied. For example, the UE may not be required to update the UE-initiated beam report content to include beam measurement corresponding to resources that may occur within the time window 336, defined by minimum time period (Z_{ref}), between the end of the DCI 335 and the start of the second UL channel 337. The UE may be configured to adjust its operation in order to override (e.g., ignore or cancel) the inclusion of the corresponding beam measurements for a resource within the time window 336 from the transmitted UE-initiated beam report.

In FIG. 3B, the reporting timeline 340 may include a first new beam 342, a current beam 343, and an Nth new beam 344 that occur at times after the first UL channel 341 is configured for the UE. The reporting timeline 330 may also include a DCI 345 and the second UL channel 347 for transmitting the UE-initiated beam reporting from the UE (to the gNB). In the reporting timeline 340, the Nth new beam 344 may be the latest resource that occurs before the time window 346, including the minimum time period (Z_{ref}) between the end of the DCI 345 and the start of the second UL channel 347 and the time window 348 including the minimum time period (Z′_{ref}). Thus, the resource for the Nth new beam 344 may be considered to satisfy the minimum time period (Z_{ref}). Accordingly, the reporting timeline determination circuitry (e.g., reporting timeline determination circuitry 155 in FIG. 2) of the UE may select Nth new beam 344 as the latest resource for UE-initiated beam reporting based on the determine reporting timeline 340.

In FIG. 3B, the reporting timeline 350 may include a first new beam 352, an Nth new beam 353, and a current beam 354 that occur at times after the first UL channel 351 is configured for the UE. The reporting timeline 350 may also include a DCI 355 and the second UL channel 357 for transmitting the UE-initiated beam reporting from the UE (to the gNB). In the reporting timeline 350, the current beam 354 may be the latest resource that occurs before the time window 356, including the minimum time period (Z_{ref}) between the end of the DCI 355 and the start of the second UL channel 357, and the time window 358 including the minimum time period (Z′_{ref}). Thus, the resource for current beam 354 may be considered to satisfy the minimum time period (Z_{ref}). Accordingly, the reporting timeline determination circuitry (e.g., reporting timeline determination circuitry 155 in FIG. 2) of the UE may select current beam 354 as the latest resource for UE-initiated beam reporting based on the determine reporting timeline 350.

In FIG. 3B, examples of reporting timelines 360, 370, and 380 may be depicted, where at least one resource may occur at a time that may not satisfy the configured minimum time period (Z_{ref}) with respect to utilizing DCI in the UE-initiated beam report transmission procedures. In some embodiments, the reporting timeline determination circuitry (e.g., reporting timeline determination circuitry 155 in FIG. 2) may be configured to execute one or more functions based on the determined reporting timelines 360, 370, and 380 and/or the minimum time period (Z_{ref}), in addition to and/or in lieu of adjusting the selection of the latest resource. The additional functions that may be performed (e.g., based on the minimum time period (Z′_{ref}) not being satisfied), can include, but are not limited to: UE overriding the inclusion of the beam measurements corresponding to the violating resource; UE overriding the scheduling DCI and dropping the UE-initiated report; the UE overriding the scheduling DCI and dropping the UE-initiated beam report if no Hybrid Automatic Repeat Request-Acknowledgment (HARQ-ACK) or transport block is multiplexed on the PUSCH; and/or other additional functions as deemed appropriate.

In FIG. 3B, the reporting timeline 360 may include a current beam 362 and a first new beam 363 that occur at times after the first UL channel 361 is configured for the UE. The reporting timeline 360 may also include a DCI 364 and the second UL channel 367 for transmitting the UE-initiated beam reporting from the UE (to the gNB), where a Nth new beam 365 occurs at a time therebetween. In the reporting timeline 360, the Nth new beam 365 may be the latest resource that occurs before the time window 368, including the minimum time period (Z′_{ref}). However, the new beam 365 occurs at a time between the end of the DCI 364 and the start of the second UL channel 367, and therefore it is within the time window 366, including the minimum time period (Z_{ref}). Thus, the resource for Nth new beam 365 may be considered to fail to satisfy the minimum time period (Z_{ref}). Accordingly, the reporting timeline determination circuitry (e.g., reporting timeline determination circuitry 155 in FIG. 2) of the UE may override including the beam measurements corresponding to the Nth new beam 365 from the UE-initiated beam report transmitted in the second UL channel 367 based on the determine reporting timeline 360.

In FIG. 3B, the reporting timeline 370 may include a first new beam 372 and a current beam 373 that occur at times after the first UL channel 371 is configured for the UE. The reporting timeline 370 may also include a DCI 374 and the second UL channel 377 for transmitting the UE-initiated beam reporting from the UE (to the gNB), where a Nth new beam 375 may be received at a time therebetween. In the reporting timeline 370, the Nth new beam 375 may be the latest resource that occurs before the time window 378, including the minimum time period (Z′_{ref}). However, the new beam 375 occurs at a time between the end of the DCI 374 and the start of the second UL channel 377, and therefore it is within the time window 376, including the minimum time period (Z_{ref}). Thus, the resource for Nth new beam 375 may be considered to fail to satisfy the minimum time period (Z_{ref}). Accordingly, the reporting timeline determination circuitry (e.g., reporting timeline determination circuitry 155 in FIG. 2) of the UE may override the beam measurements corresponding to the Nth new beam 375 from the UE-initiated beam report (e.g., beam measurements are not included in the report) transmitted in the second UL channel 367 based on the determine reporting timeline 370.

In FIG. 3B, the reporting timeline 380 may include a first new beam 382 and Nth new beam 383 that occur at times after the first UL channel 381 is configured for the UE. The reporting timeline 380 may also include a DCI 384 and the second UL channel 387 for transmitting the UE-initiated beam reporting from the UE (to the gNB), where a current beam 385 occurs at a time therebetween. In the reporting timeline 380, the current beam 385 may be the latest resource that occurs before the time window 388, including the minimum time period (Z′_{ref}). However, the current beam 385 occurs at a time between the end of the DCI 384 and the start of the second UL channel 387, and therefore it is within the time window 386, including the minimum time period (Z_{ref}). Thus, the resource for current beam 385 may be considered to fail to satisfy the minimum time period (Z_{ref}). Accordingly, the reporting timeline determination circuitry (e.g., reporting timeline determination circuitry 155 in FIG. 2) of the UE may override the beam measurements corresponding to the current beam 385 from the UE-initiated beam report transmitted in the second UL channel 387 based on the determine reporting timeline 380.

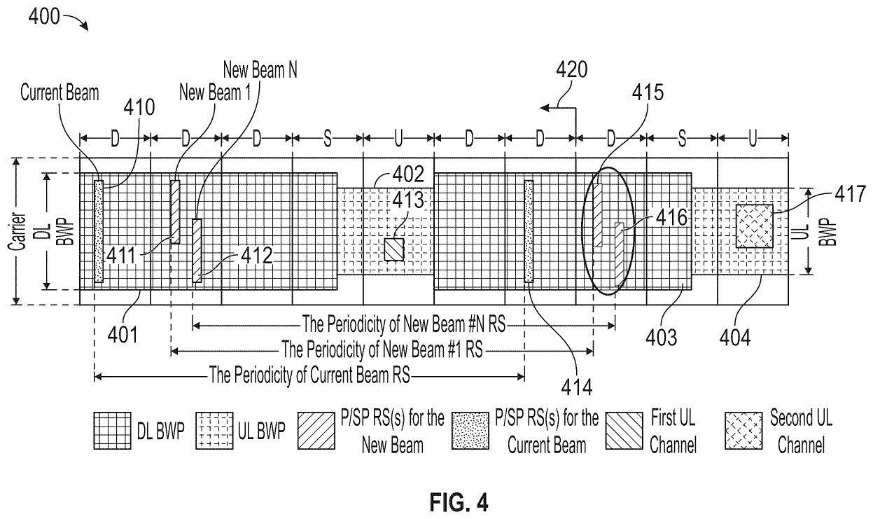

FIG. 4 is a diagram illustrating examples of reporting timeline that may be determined using procedures based on a CSI reference resource, according to some embodiments of the present disclosure.

In accordance with some wireless communication technology standards (e.g., 5G), a CSI reference resource may refer to a resource utilized to transmit a reference signal for UE beam reporting. For example, a gNB may configure a CSI reference resource for the UE, where reference signals are transmitted within the resource that can be measured to estimate channel conditions and report CSI parameters to the gNB. The UE's measurements based on the CSI reference resource may be used for other beam management functions, such as enabling the selection of optimal beams for improved signal quality.

In the example of FIG. 4, the UE (e.g., UE device 112 in FIG. 1) may be configured for implementing UE-initiated beam reporting. Further, the reporting timeline determination circuitry (e.g., reporting timeline determination circuitry 155 in FIG. 2) of the UE may be configured to determine the reporting timeline 400 depicted in FIG. 4 based on the CSI reference resource(s). In some embodiments, the UE may be configured to implement “Mode B” operations for the UE-initiated beam report transmission procedures.

The reporting timeline 400 may involve the gNB transmitting a configuration to the UE, specifying the CSI reference resource(s) 420 to be used for measurement and reporting. In some embodiments, the UE-initiated beam report transmitted in the second UL channel 417 may be based on the CSI reference resource(s) 420. For example, a report quantity (e.g., number of resources having measurements included in the UE-initiated beam reporting) can be based on measuring the RSs for current beam(s) and/or new beam(s) during a time period before (e.g., no later than) a time associated with the configured CSI reference resource(s) 420 relative to the first symbol on the second UL channel.

In some embodiments, the time period associated with the CSI reference resource(s) may be statically configured (e.g., pre-defined by the UE and/or gNB, etc.), dynamically configured, and/or semi-statistically configured. In some embodiments, the time period associated with the CSI reference resource(s) may be derived based on capabilities of the UE (e.g., indicated via capability signaling), and therefore can be reported by the UE to gNB.

In FIG. 4, the reporting timeline 400 may include periodic/semi-persistent (P/SP) RSs for current beams and multiple new beams. In the example, DL bandwidth parts (BWPs) 401 may be utilized for transmitting the RS for current beam 410, the RS for the first new beam 411, and a Nth new beam 412 (e.g., via DL slots). Thereafter, an UL BWPs 402 may be utilized for transmissions on the first UL channel 413 (e.g., including the notification from the UE of the second UL channel 417 used to carry the UE-initiated beam report). Subsequently, DL BWPs 403 may be utilized for transmitting the RS for current beam 414, the RS for the first new beam 415, and the Nth new beam 416 (e.g., via DL slots). The UL BWPs 404 may be utilized for transmissions on the second UL channel 417, for example including the UE-initiated beam report (e.g., via an UL slot). Also, FIG. 4 illustrates that the RSs of the current beam 414 may be another periodic instance of the previous RSs of the current beam 410, and the RSs of the first new beam 415, and the Nth new beam 416 may be other period instances of the previous RSs of the first new beam 411, and the Nth new beam 412, respectively. Although the example of FIG. 4 depicts that the periodicity of the RSs for the current beams 410, and the new beams 411, 412, 415, 416 may be substantially equal (e.g., same), the present disclosure is not limited thereto, and the periodicity may differ in some embodiments.

The CSI reference resource(s) 420 may be defined relative to the UL BWP 404 (e.g., UL slot) configured for carrying the second UL channel 417. For example, the CSI reference resource(s) 420 may be represented mathematically as:

$$n - {n}_{CSI\_ref} - {K}_{offset} \cdot \frac{{2}^{{μ}_{DL}}}{{2}^{{μ}_{{K}_{offset}}}} \qquad ( eq . 1 )$$

where n is a downlink slot determined according to the uplink slot n′ in which the second UL channel is transmitted, n_{CSI_ref} is specified in TS 38.214, K_{offset} is configured by higher layer as specified in TS 38.213, μ_{DL} is the subcarrier spacing configurations for DL, and μ_{K}_{_{offSet}} is the subcarrier spacing configuration for K_{offset}

The UE-initiated beam report communicated in the second UL channel 417 may be based on the transmitted instances of the current beam 410, first new beam 411, Nth new beam 412, and the current beam 414 occurring at times during a time period before (e.g., no later than) a time associated with the CSI reference resource(s) 420, where the CSI reference resource may be determined relative to the start of the second UL channel 417 (e.g., first symbol). In some embodiments, the time associated with the CSI reference resource may be relative particularly to a first symbol in the UL slot corresponding to the second UL channel. For example, the UE may determine that the two instances of RSs for the first new beam 415 and the Nth new beam 416 may not satisfy the time requirement of occurring before the CSI reference resource(s) 420 based on the determined reporting timeline 400. Accordingly, the UE may override the beam measurements corresponding to the first new beam 415 and the Nth new beam 416 in the UE-initiated beam report (e.g., beam measurements are not included in the report) that is transmitted in the second UL channel 417. Due to the instances of the RSs for the first new beam 415 and the Nth new beam 416 occurring later than the CSI reference resource(s) 420, the beams may not contribute to the evaluation of the beam measurements that are reported in the second UL channel 417.

In some embodiments, the reporting timeline determination circuitry (e.g., reporting timeline determination circuitry 155 in FIG. 2) may be configured to execute one or more functions based on the determined reporting timelines 400 the time period based on the CSI reference resource (relative to the second UL channel). For example, if an event is no longer satisfied (e.g., after conducting further measurement based on RSs transmitted before the CSI reference resource relative to the second UL channel, and after transmitting the first UL channel), a reserved value may be reported (e.g., including zeros), such that the adjusted (e.g., modified) UE-initiated beam report may have a payload of a substantially similar size to the original reported. In some embodiments, the UE may be configured to drop (e.g., not transmit) the UE-initiated beam report. Additionally, in some embodiments, if the payload size of the original UE-initial beam report changes (e.g., after conducting further measurement based on RSs transmitted no later than CSI reference resource relative to the second UL channel, and after transmitting the first UL channel), a UE may be configured to perform padding until the payload is substantially a similar size of the previous payload (e.g., when the event is triggered). In some embodiments, padding may involve using one or more determined values (e.g., zeros). Alternatively, in some embodiments, the UE may be configured to transmit the actual payload (e.g., after the payload size of the original UE-initial beam report changes) without padding.

In some embodiments, the reporting timeline determination circuitry (e.g., reporting timeline determination circuitry 155 in FIG. 2) of the UE may be configured to implement UE-initiated beam reporting procedures based on a time period before (e.g., no later than) the configured CSI reference resource(s) relative to the first symbol on the first UL channel.

For example, referring back to FIG. 4, the UE-initiated beam report transmitted in the second UL channel 417 can be based on measuring instances of RSs for the current beam 410, the first new beam 411, and the Nth new beam 412 which may be transmitted no later than the CSI reference resource determined relative to the first UL channel 413.

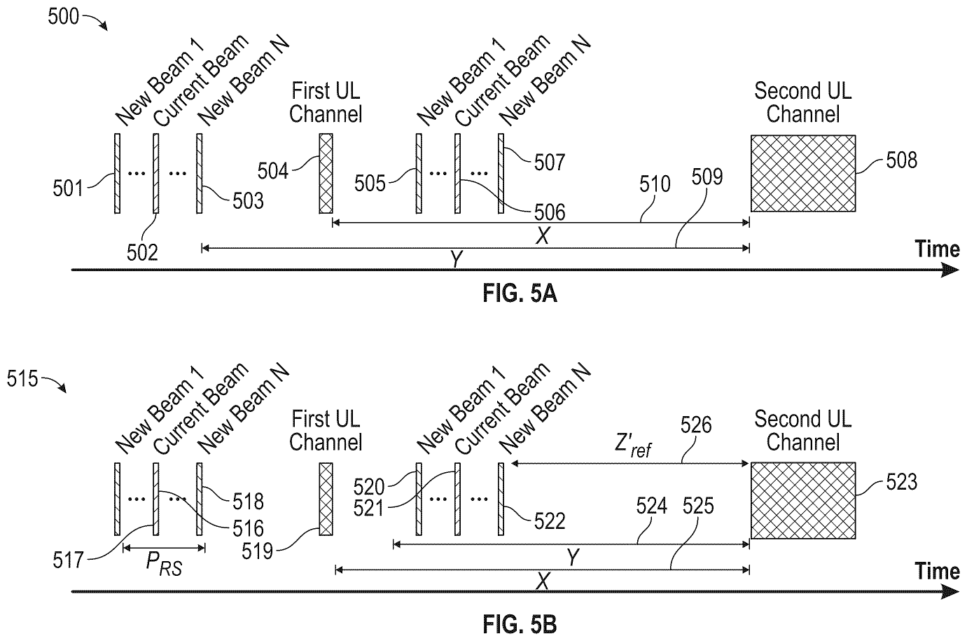

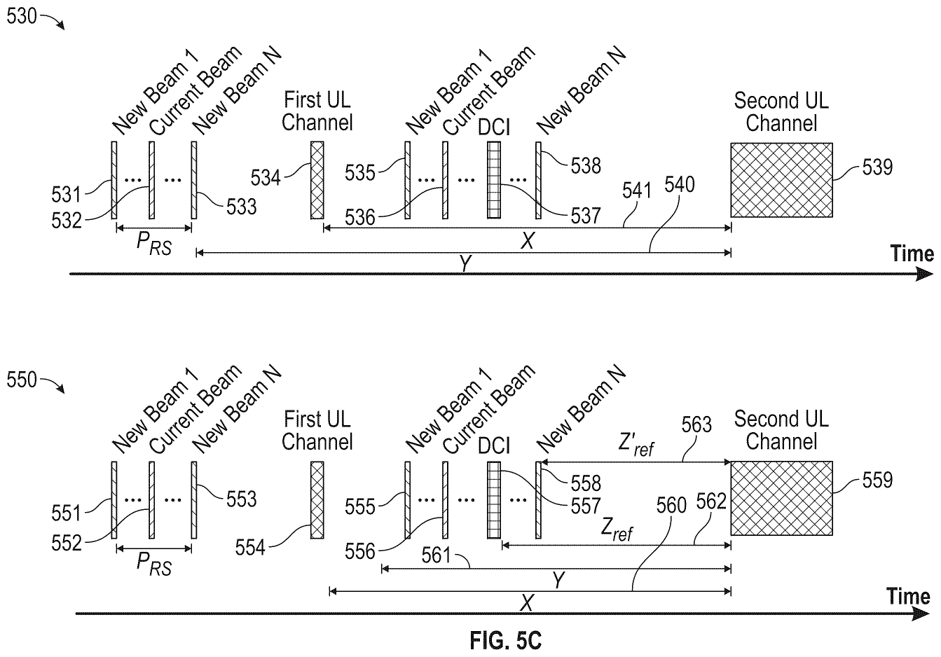

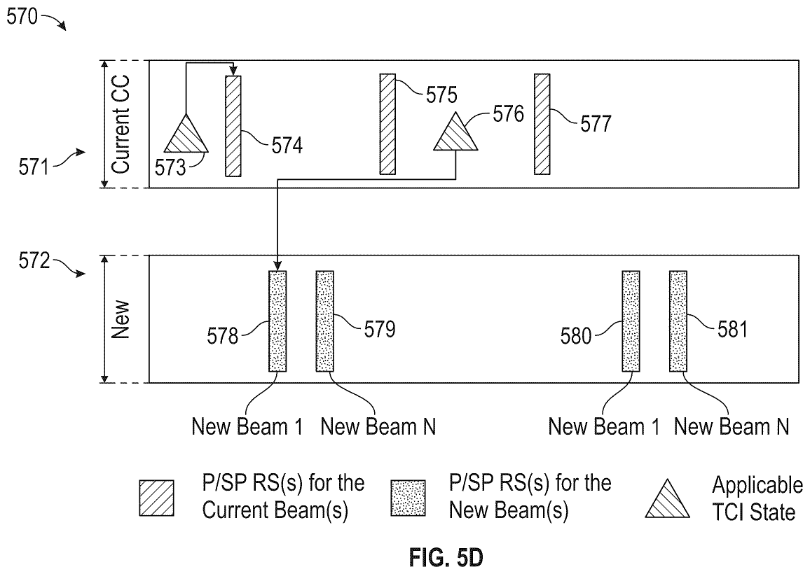

FIG. 5A includes diagrams illustrating examples of reporting timelines that may be determined using procedures based on a configured maximum reliability time period (e.g., time window), according to some embodiments of the present disclosure.

In the examples of FIG. 5A a UE (e.g., UE device 112 in FIG. 1) may be configured for implementing UE-initiated beam reporting. Further, the reporting timeline determination circuitry (e.g., reporting timeline determination circuitry 155 in FIG. 2) of the UE may be configured to determine the reporting timelines 500 depicted in FIG. 5A with respect to the UE being configured to implement “Mode B” operations for the UE-initiated beam report transmission procedures.

Another temporal consideration related to UE-initiated beam reporting may be related to a length of time that lapses between the occurrences of the beams and/or obtained measurements of the RSs for the beams, and the time of the transmission of the UE-initiated beam report from the UE (to the gNB). In some wireless communication environments, the dynamic nature of UE mobility and environmental factors can cause significant changes related to the network and the signal quality of the beams to be experienced in a relatively short amount of time. Thus, using earlier occurrences of beams for reporting which occurred at comparatively long time periods before the reporting (e.g., the second UL channel) may cause a substantial time lapse to be experienced between acquiring the beam measurement data and the reporting of that data, which may, in turn, lend itself to having outdated beam measurements that are included in the UE-initiated beam report. Reporting such “outdated” beam measurements to the network (e.g., gNB) may lead to errors, inaccuracies, unexpected behaviors, and/or inefficiencies related to the UE-initiated beam reporting procedures. Furthermore, such unreliability in the UE-initiated beam reporting may ultimately impact the overall performance of the beam management functions (e.g., selecting a beam based on inaccurate beam measurement information) and the wireless communication network.

Accordingly, FIG. 5A illustrates an example of a reporting timeline 500 that may be determined for UE-initiating beam reporting that can be based on a maximum reliability time period (Y), which is a value for a number of symbols that may represent an amount of time (e.g., time window). As used herein, “symbol” may refer to a fundamental unit of time (in the Orthogonal Frequency-Division Multiplexing (OFDM) structure) that carries a portion of the signal. For example, UL channels may be built from one or more symbols, such as a PUCCH which can use one or two symbols for short formats or 4 to 14 symbols for long formats. Symbols may be used to carry various types of information, including user data (on PUSCH) and/or control information (e.g., HARQ feedback) (on PUCCH).

By utilizing a defined maximum reliability time period (Y), there may be increased flexibility that is supported within the UE-initiated beam reporting procedure, as the quantitative and/or measurable value(s) can be used to consider the temporal reliability and/or validity of the beam report content, which is communicated between the UE and the network (e.g., gNB). As used herein, the maximum reliability time period (Y) may refer to a threshold for a maximum number of symbols calculated backward relative from a first symbol of the second UL channel to a last symbol of an earliest beam (e.g., most prior occurrence of a beam having measurements that are included in the UE-initiated beam report). In some embodiments, the maximum reliability time period (Y) may be statically configured (e.g., pre-defined by the UE and/or gNB, etc.), dynamically configured (e.g., indicated to the UE, based on the conditions of the network, etc.), and/or semi-statistically configured. In some embodiments, the maximum reliability time period “Y” may be derived based on capabilities of the UE (e.g., indicated via capability signaling), and therefore can be reported by the UE to gNB.

In FIG. 5A, the reporting timeline 500 may include a first new beam 501, a current beam 502, and an Nth new beam 503 that occur at times before the first UL channel 504 is configured for the UE. Also, a first new beam 505, a current beam 506, and an Nth new beam 507 may occur at times after the first UL channel 501, and before the occurrence of the second UL channel 508 for transmitting the UE-initiated beam report from the UE (to the gNB). In the example of FIG. 5A, the maximum reliability time period (Y) may be determined backward relative from a first symbol of the second UL channel 508. A time window 509, including the maximum reliability time period (Y), is shown to span an amount of time from the first symbol (e.g., start) of the second UL channel 508 to the last symbol (e.g., end) of the Nth new beam 503. For example, in the reporting timeline 500, any beams that may be received before the time window 509 can be determined to exceed the threshold of the maximum reliability time period (Y) and may be considered unreliable for beam reporting. Conversely, any beams that may be received during the time window 509 can be determined to satisfy the threshold of the maximum reliability time period (Y) and may be considered reliable for beam reporting. In some embodiments, the UE may be configured to continue to update the UE-initiated report content with measurements of RSs for any beams received during the time window satisfying the maximum reliability time period (Y).

The first new beam 505, the current beam 506, and the Nth new beam 507 which may be received at times within the time window 509 may be considered to satisfy the threshold of the maximum reliability time period (Y). Accordingly, the reporting timeline determination circuitry (e.g., reporting timeline determination circuitry 155 in FIG. 2) of the UE may select measurements of RSs for the first new beam 505, the current beam 506, and the Nth new beam 507 to be included in the UE-initiated report transmitted by the second UL channel 508.

In FIG. 5A, a time window 510, including another time period (X), is illustrated relative to the time window 509, including the maximum reliability time period (Y) in the reporting timeline 500. As used herein, the “time period (X)” may refer to an amount of time between a last symbol (e.g., end) of the first UL channel 504 transmission and a first symbol (e.g., start) of the second UL channel 508 transmission. The reporting timeline 500 depicts a scenario where the maximum reliability time period (Y) may be longer than the time period (X) (e.g., Y>X), the time window 509 may be greater than the time window 510 and extending to a time before the first UL channel 504 transmission. In this case, one or more beams that may have initiated the event-driven trigger for the UE-initiated beam reporting may have been received within the time window 509, and thus may also satisfy the threshold of the maximum reliability time period (Y).

As a result, at least some of the beams that may have been used to determine whether the event is triggered for configuring the first UL channel 504 (e.g., initiating the UE-initiated beam reporting procedure) may also have measurements that are reported in the second UL channel 508 transmission. The functionality that may be achieved by implementing the reporting timeline 500 (e.g., where the maximum reliability time period (Y) may be longer than the time period (X)), for example, may improve consistency with respect to the content of the UE-initiated beam report from a perspective of capturing the information that may be relevant to the conditions at times close to and/or shortly prior to the time of the first UL channel 504 transmission (e.g., including time near the event-driven trigger). For instance, the UE-initiated beam report transmitted by the second UL channel 508 may capture information representing the signal quality and/or network conditions of the beams that triggered the UE-initiated beam reporting, even if the triggered event may no longer be valid by the time of the second UL channel 508 transmission.

In FIG. 5B, the reporting timeline 515 may include a first new beam 516, a current beam 517, and an Nth new beam 518 that occur at times before the first UL channel 519 is configured for the UE. Also, a first new beam 520, a current beam 521, and an Nth new beam 522 may occur at times after the first UL channel 519 transmission, and before the occurrence of the second UL channel 523 for transmitting the UE-initiated beam report from the UE (to the gNB). In the example of FIG. 5B, the maximum reliability time period (Y) may be determined backward relative from a time of the first symbol (e.g., start) of the second UL channel 523. A time window 524, including the maximum reliability time period (Y), is shown to span an amount of time from the first symbol (e.g., start) of the second UL channel 508 transmission to a time before the occurrence of the first new beam 520 (e.g., prior to the start) and after the first UL channel 519 transmission (e.g., after the end). Accordingly, in the reporting timeline 500, the first new beam 516, the current beam 517, and the Nth new beam 518 received at times prior to the time window 524 may be considered to exceed the threshold of the maximum reliability time period (Y). The first new beam 520, the current beam 521, and the Nth new beam 522 which may be received at times within the time window 524 may be considered to satisfy the threshold of the maximum reliability time period (Y). Accordingly, the reporting timeline determination circuitry (e.g., reporting timeline determination circuitry 155 in FIG. 2) of the UE may select measurements of RSs for the first new beam 520, the current beam 521, and the Nth new beam 522 to be included in the UE-initiated report transmitted by the second UL channel 523.

In FIG. 5B, the time window 525, including the time period (X), and the time window 526, including the minimum window time period (Z′_{ref}), are illustrated relative to the time window 524, including the maximum reliability time period (Y) in the reporting timeline 515. The reporting timeline 515 depicts a scenario where the maximum reliability time period (Y) may be shorter than the time period (X) (e.g., Y<X), and the time window 525 may be greater than the time window 524. In some embodiments, the maximum reliability time period (Y) can be particularly configured to be larger than the minimum reliability window (Z_{ref}). As seen in FIG. 5B, neither time windows 524, 525 extend before the occurrence of the first UL channel 519. In this case, it may be assumed that none of beams that may have initiated the event-driven trigger for the UE-initiated beam reporting (e.g., one or more beams received before the first UL channel 519 transmission) can be received within the time window 524, exceed the threshold of the maximum reliability time period (Y), and may not be included in the UE-initiated beam report transmitted in the second UL channel 523. However, when the maximum reliability time period (Y) can be configured to be less than the time period (X) (e.g., Y<X), it can be assumed that at least some of the beams received at a time relatively closer to the occurrence of the second UL channel 504 (e.g., the UE-initiated beam reporting transmission) may have measurements that are reported in the second UL channel 523 transmission.

The functionality that may be achieved by implementing the reporting timeline 515 (e.g., where the maximum reliability time period (Y) may be shorter than the time period (X)), for example, may improve reliability and the optimizing of timing with respect to the content of the UE-initiated beam report from a perspective of capturing the information that may be relevant to the conditions at times close to and/or shortly prior to the time of the second UL channel 504 transmission (e.g., including the UE-initiated beam report). For instance, the UE-initiated beam report transmitted by the second UL channel 523 may capture information representing the signal quality and/or network conditions of beams received at times relatively proximate to the time of the beam reporting transmission, in the case that a triggered event (occurring prior to the first UL channel 519 transmission) may no longer be valid by the time of the second UL channel 508 transmission. By utilizing measurements of beams occurring at times closer to the actual reporting transmission, the content of the UE-initiated beam report may be considered more reliable and appropriately timed in scenarios of high mobility and/or high traffic condition, for instance when the gNB may delay resource allocation for the second UL channel 523.

FIG. 5C includes diagrams illustrating examples of reporting timelines that may be determined using procedures based on a configured maximum reliability time period (e.g., time window), according to some embodiments of the present disclosure.

In the examples of FIG. 5C the UE (e.g., UE device 112 in FIG. 1) may be configured for implementing UE-initiated beam reporting. Further, the reporting timeline determination circuitry (e.g., reporting timeline determination circuitry 155 in FIG. 2) of the UE may be configured to determine the reporting timelines 530, 550 depicted in FIG. 5C with respect to the UE being configured to implement “Mode A” operations for the UE-initiated beam report transmission procedures.

In FIG. 5C, the reporting timeline 530 may include a first new beam 531, a current beam 532, and an Nth new beam 533 that occur at times before the first UL channel 534 is configured for the UE. The reporting timeline 530 may also include a DCI 537 to indicate the resource for a second UL channel to carry the UE-initiated beam report, and the second UL channel 347 for transmitting the UE-initiated beam reporting from the UE (to the gNB). Also, the reporting timeline 530 may include a first new beam 535 and a current beam 536 which may be received at times after the first UL channel 534, and an Nth new beam 533 that may be received at a time after the first UL channel 534 transmission and before the time of the second UL channel 347 transmission.

In the example of FIG. 5C, the maximum reliability time period (Y) may be determined backward relative from a first symbol of the second UL channel 508. A time window 540, including the maximum reliability time period (Y), is shown to span an amount of time from the first symbol (e.g., start) of the second UL channel 539 to the last symbol (e.g., end) of the Nth new beam 533 (before the first UL channel 534). The first new beam 535, the current beam 536, and the Nth new beam 538 which may be received at times within the time window 540 may be considered to satisfy the threshold of the maximum reliability time period (Y). Accordingly, the reporting timeline determination circuitry (e.g., reporting timeline determination circuitry 155 in FIG. 2) of the UE may select measurements of RSs for the first new beam 535, the current beam 536, and the Nth new beam 538 to be included in the UE-initiated report transmitted by the second UL channel 508. FIG. 5C, also illustrates that reporting timeline 530 may be determined based on the maximum reliability time period (Y) being configured to be greater than the time period (X), such that the time window 540, including maximum reliability time period (Y) may be longer than the time window 541, including the time period (X) between the occurrences of the first UL channel 534 and the second UL channel 539.

In FIG. 5C, the reporting timeline 550 may include a first new beam 551, a current beam 552, and an Nth new beam 553 that occur at times before the first UL channel 554 is configured for the UE. The reporting timeline 550 may also include a DCI 557 to indicate the resource for a second UL channel to carry the UE-initiated beam report, and the second UL channel 559 for transmitting the UE-initiated beam reporting from the UE (to the gNB). Also, the reporting timeline 550 may include a first new beam 555 and a current beam 556 which may be received at times after the first UL channel 554, and an Nth new beam 558 that may be received at a time after the first UL channel 554 transmission and before the time of the second UL channel 559 transmission.

In the example of FIG. 5C, the maximum reliability time period (Y) may be determined backward relative from a first symbol of the second UL channel 559. A time window 561, including the maximum reliability time period (Y), is shown to span an amount of time from the first symbol (e.g., start) of the second UL channel 559 transmission to a time before the occurrence of the first new beam 555 (e.g., prior to the start) and after the first UL channel 554 transmission (e.g., after the end). Accordingly, in the reporting timeline 550, the first new beam 551, the current beam 552, and the Nth new beam 553 which may be received at times prior to the time window 561 may be considered to exceed the threshold of the maximum reliability time period (Y). The first new beam 555, the current beam 556, and the Nth new beam 558 which may be received at times within the time window 524 may be considered to satisfy the threshold of the maximum reliability time period (Y). Additionally, in the reporting timeline 550, the Nth new beam 558 may be determined to be the latest resource that occurs before the time window 563, thus satisfying the threshold of the minimum time period (Z′_{ref}). However, the Nth new beam 558 occurs at a time between the end of the DCI 557 and the start of the second UL channel 559, and therefore it may be received within the time window 562. Thus, the Nth new beam 558 may be considered to fail to satisfy the minimum time period (Z_{ref}). Accordingly, the reporting timeline determination circuitry (e.g., reporting timeline determination circuitry 155 in FIG. 2) of the UE may be configured to override the threshold relating to the maximum reliability time period (Y), and may not include the measurements of the RSs for the Nth new beam 558 in the UE-initiated beam report transmitted in the second UL channel 559. The reporting timeline 550 illustrates that the functions of the UE-initiated beam reporting procedure, for instance the contents of the UE-initiated beam report, may be dynamically adjusted based on which thresholds are applied and the additional functions that the UE may be configured to perform based on detecting a violation of the threshold(s). The reporting timeline determination circuitry may be configured to applying two or more of the thresholds described in reference to FIGS. 3A-5C, and may dynamically adjust the UE-initiated beam reporting transmission based on the multiple thresholds (e.g., override the selection of a measurement corresponding to a beam that is detected to violate one threshold out of three thresholds that are applied). In some embodiments, the thresholds described in reference to FIGS. 3A-5C may be assigned a priority, and the reporting timeline determination circuitry may be configured to apply and/or override content adjustment to the UE-initiated beam report based on the priorities.

In some embodiments, the reporting timeline determination functions and/or circuitry (e.g., reporting timeline determination circuitry 155 in FIG. 2) may be configured to execute one or more content adjustment functions for the UE-initiated beam report based on detecting violation(s) of the determined reporting timeline. For example, referring back to the example reporting timeline 550 of FIG. 5C, it may be possible that during the time window 561, including the maximum reliability time period (Y) (and after the first UL channel 554 transmission), the event-trigger associated with activating the UE-initiated beam report may no longer be valid (e.g., active). In this case, the reporting timeline determination circuitry may be configured to detect the status of the event-trigger, and subsequently may drop (e.g., does not execute) the transmission of the UE-initiated report on the second UL channel 559. However, in dropping the second UL channel 559 transmission, there may be some ambiguity regarding whether a retransmission of the second UL channel may be necessary (e.g., other functions performed by the network may be contingent on the gNB receiving the second UL channel 559 transmission). Accordingly, the reporting timeline determination circuitry may be configured to perform an adjustment of the content for the UE-initiated beam report in response to detecting the expired event-trigger, such as including measurements corresponding to the current beam 556 in the UE-initiation beam report transmitted in the second UL channel 559, which still allows a report transmission to occur (limited to the current beam) on the second UL channel 559 in a manner that may prevent any retransmission ambiguity. Dynamically adjusting the content of the UE-initiated beam report to be limited to the current beam may be implemented for different RRC configurations (e.g., reporting of the current beam, reporting current beam in addition to the N new beams, etc.)

In some embodiments, the reporting timeline determination functions and/or circuitry (e.g., reporting timeline determination circuitry 155 in FIG. 2) may be configured to execute one or more additional content adjustment functions for the UE-initiated beam report based on detecting violation(s) of the determined reporting timeline, such as adjusting the UE-initiated beam report to include a reserved value (e.g., a set number of zeros) such that the report may have the same payload size of a defined (e.g., intended) UE-initiated beam reported. In some embodiments, the reporting timeline determination circuitry may also be configured to execute adjusting the UE-initiated beam report to include a set of beams that is substantially similar (e.g., same) to the beams received relative to the first UL channel 554 (e.g., as if no change occurred within the time between the first UL channel to the second UL channel), in response to a detected violation of the determined reporting timeline. In this function, the same set of beams may be included in the UE-initiated beam report but also having their updated beam measurement values reported (e.g., the requirement of at least one beam out of N reported beams should satisfy the event condition may no longer be met in such report). In some embodiments, in response to detecting a violation of the reporting timeline, the reporting timeline determination circuitry may also be configured to execute adjusting the UE-initiated beam report to include specific beam index(es) and/or corresponding beam measurements (e.g., for beams that fail to satisfy a threshold) that may be replaced with the reserved value (e.g. a set number of zeros).

In some embodiments, in response to detecting a violation of the reporting timeline, the reporting timeline determination circuitry may also be configured to execute adjusting the UE-initiated beam report to include a filtering of the beam measurements, for example performing a collective calculation of a beam measurement vale that corresponds to multiple beams that are received (e.g. averaging L1-RSRP measurements over time). There may be operational trade-offs associated with performing filtering of the beam measurements (e.g., missing and/or delaying occurrence of rapid variations and possible trigger-events in high mobility scenarios), in some environments, and thus the reporting timeline determination circuitry may be configured to dynamically apply filtering as a violation response action based on various related criteria (e.g., mobility of the UE device, environment/channel conditions, etc.).

FIG. 5D includes a diagram illustrating an example of a timeline 570 that may be determined based on multiple carriers (CC) operation related to UE-initiated beam reporting, the according to some embodiments of the present disclosure.

According to some wireless communication technology standards (e.g., 5G NR), multiple carriers (also referred to herein as “component carriers” or CCs) may be utilized in a Carrier Aggregation (CA) operation and managed for beamforming either independently or in a coordinated manner such that the UE may maintain a relatively strong (or strongest possible) connection across all of the assigned CCs. As used herein, a “component carrier” (or CC) may refer to individual frequency bands wireless networks use to transmit data. For example, during CC operation, the UE may perform CA functions that can include being connected (simultaneously) to multiple CCs from one or more base stations (or gNBs), which enables the UE to receive data from the multiple CCs simultaneously in a manner that may increase the total available bandwidth, increase data speed, and improve data rates. For the purpose of beam management, the UE may have the capability to measure different types of RSs to assess the quality of beams across the CCs, and by measuring the RS corresponding to the CCs and beam, it may then be determined that a “best beam” (e.g., beam with highest power) for the UE can be a current beam and/or a potential new beams, which may be transmitted within different carriers (or CCs). In the example of FIG. 5D, the UE (e.g., UE device 112 in FIG. 1) may be configured for implementing UE-initiated beam reporting based on multiple CC operation, as disclosed herein. Further, the reporting timeline determination circuitry (e.g., reporting timeline determination circuitry 155 in FIG. 2) of the UE may be configured to determine the reporting timeline 570 depicted in FIG. 5D using functions related to multiple CC operation to realize various advantages with respect to beam management, such as recovering the deterioration of a current beam, which may be transmitted within a current CC, using a new beam that may be transmitted within a new, different CC.

In the example timeline 570, an example of CC operation is depicted that may involve a current CC 571 and a different new CC 572 which may be configured for beamforming, where current beams 574, 575, and 575 may be received by the UE (e.g., transmitted by a gNB) within the current CC 571; and a first new beam 578, nth new beam 579, first new beam 580, and nth new beam 581 may be received by the UE (e.g., transmitted by a different gNB) within the new CC 572. The UE may be configured to measure the strength of RSs (e.g., CSI-RS) for the different received beams within both current CC 571 and the new CC 572. For example, a UE-initiated beam measurement report may include measurements for one or more of the current beams 574, 575, 575 received in the current CC 571, or one or more of the new beams 578-581 received in the new CC 571, where the beam measurements may provide information about potential new “target” beams to the network (e.g., gNB) in beam management functions.

In some embodiments, the UE may be configured to determine the current CC 571 as one, or a combination of, the following: current CC is the CC in which the UE-initiated beam report is transmitted (regardless of the location of an indicated Transmission Configuration Indicator (TCI) and a Quasi Co-Location (QCL) source RS); current CC is the CC in which TCI may be configured (e.g., indicated, or activated) (regardless of the location of the transmitted UE-initiated beam report and the QCL source RS of this TCI state); or current CC is the CC in which QCL source RS of the indicated TCI is transmitted (regardless of the location of the indicated TCI or the transmitted UE initiated beam report).

In some embodiments, the UE may be configured to determine the new CC 572 as one, or a combination of, the following: new CC is the CC in which RSs for the new beam(s) are transmitted; or new CC is the CC in which the UE-initiated beam management report is transmitted.

In the example of FIG. 5D, the current CC 571 and the new CC 572 may be different CCs (not the same CC), and thus it may be beneficial for the UE to have the capability to select one or more of the identified new beam(s) 578-581 received within the new CC 572 to be used by the UE, for example in beam switching (e.g., to recover the deterioration of a current beam 575 in the current CC 571). For example, the UE may determine that at least one of the configured TCI states that is to be applied in the current CC can indicate a RS of a new beam as its QCL source RS. In other words, the UE may expect at least one of the applicable TCI states in the current CC to have its QCL source RS to be an RS of a new beam.

In the example of FIG. 5D, the current CC 571 may correspond to two TCI states that can be configured for the UE, shown as TCI states 573, 576. The TCI state 573 may be set to include the RS of the current beam 574 as its corresponding QCL source RS. Additionally, the TCI state 576 may be set to include the RS of the new beam 578 as its corresponding QCL source RS. Accordingly, in this timeline 570, if the current beam 575 experiences a degradation in signal quality that is detected by the UE as an event-trigger for UE-initiated beam reporting functions, as disclose herein, the new beam 578 may be identified (with beam measurements within the UE-initiated beam report) as having a signal quality that is suitable to replace the current beam 575. The UE-initiated beam report and indicated “better beam” may cause the TCI state 576 to be activated, which has its corresponding QCL source RS set as the RS of the new beam 578. Thus, the new TCI state 576 may point to a better, specific source RS of the new beam 578 on the other component carrier (which is the RS for new beam 578 received within new CC 572) based on the data of the UE-initiated measurement report.

In some embodiments, the RSs of each of the received new beams can be a QCL source RS of the TCI for the current beam. For example, referring back to the example timeline 570, the TCI state 576 can be configured to have its corresponding QCL source RS set as the RSs for one or more of the new beams 578 578-581 in new CC 572. This approach may ensure that for any identified new beam, there is at least one applicable TCI state that can be used for the current CC. In other words, a UE may expect that each RS of the new beam is at least a QCL source RS of one of the configured TCI states for the current CC. Furthermore, in some embodiments, the gNB may be the component that configures the TCI states (e.g., TCI states 574, 575 in FIG. 5D), for example including the TCI state ID in the DCI transmitted to the UE (e.g., indicating to the UE which spatial beam to use to receive the scheduled data). Accordingly, in some embodiments, the reporting timeline determination function and/or circuitry of the gNB (e.g., reporting timeline determination 145 in FIG. 1) may be configured to implement one of more aspects of UE-initiated beam reporting based on multiple CC operation, as disclosed herein.

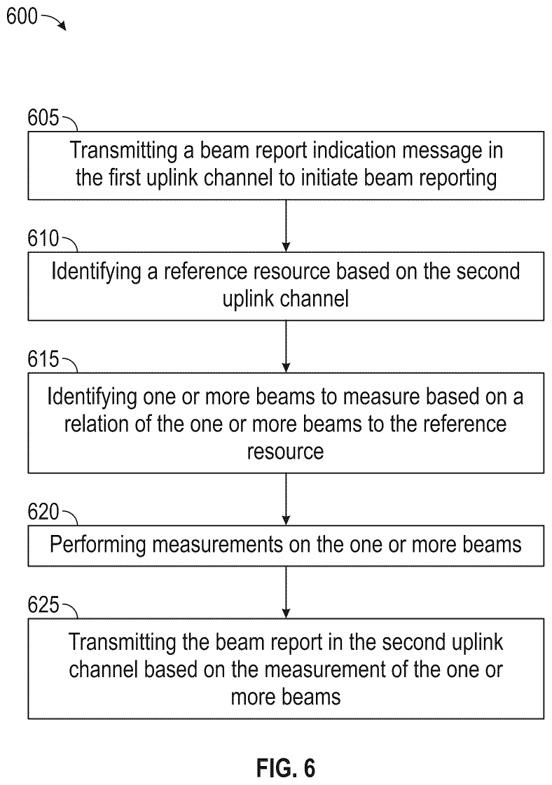

FIG. 6 is a flowchart illustrating a method 600 implementing UE-initiated beam reporting including reporting timeline determination, according to some embodiments of the present disclosure.

Although FIG. 6 illustrates various operations in an example UE-initiated beam reporting method 600 according to some embodiments, embodiments according to the present disclosure are not limited thereto. For example, according to some embodiments, the UE-initiated beam reporting method 600 may include additional operations or fewer operations, or the order of operations may vary, unless otherwise stated or implied, without departing from the spirit and scope of embodiments according to the present disclosure. In some embodiments, the method 600 may be implemented by the UE-initiated beam reporting circuit 150 as described in greater detail in reference to FIG. 2.

The method 600 may start at operation 605 by transmitting a beam reporting indication message in a first UL channel to initiate beam reporting. The UE-initiated beam reporting transmission procedures may be implemented by the UE in accordance with “Mode A” operation or “Mode B” operations, as disclosed herein. Accordingly, a first UL channel may be used by a UE device to transmit an indication of the UE-initiated report to the gNB and a second UL channel may be used by the UE device to transmit the UE-initiated report to the gNB at a later time (e.g., after the reporting timeline determination). The UE may receive one or more beams from a gNB (e.g., see FIG. 1). The UE may be configured to detect a trigger-event related to the received beam which may be indicative of the channel (or environment) conditions, for example sensing that the signal power of the beam (e.g., RSRP) may be below a defined threshold. As a result of detecting the event-trigger associated with the beam received, the UE may activate UE-initiated beam reporting procedures, such as transmitting the beam reporting indication message in a first UL channel as executing in operation 605, in order to support generating and/or transmitting the UE-initiated beam report to communicate beam measurements to the network (e.g., gNB) to facilitate beam management functions for the UE.

At operation 610, a reference resource may be identified based on the second uplink channel. For example, the UE may be configured to identify the reference resource by determining a time associated with a CSI reference resource, such as CSI-RS, which can be utilized for performing beam measurements. The CSI reference resource may be identified based on the type of CSI reporting that is configured to be performed, for instance the CSI reference resource may be defined based on an aperiodic CSI reporting and relative to the second UL channel. As a function of the reporting timeline determination, as disclosed herein, operation 610 may involve the UE determining a time related to the CSI reference resource based on an DL slot (e.g., for transmitting the CSI-RS) relative to an UL slot corresponding to (e.g., for transmitting) the second UL channel, and further based on a subcarrier spacing configuration for the downlink slot and an offset value (e.g., using defined eq(1)). In some embodiments, the reference resource may be identified based on the first UL channel, where the time related to the CSI reference resource may be determined relative to the first UL channel.

At operation 615, identifying one or more beams to measure may be performed based on a relation of the one or more beams to the reference resource. For example, the UE may receive one or more beams (e.g., current beams, new beams) that may have beam measurements that can be included in the beam report. For example, the UE may receive a first beam transmitted from the gNB, and then receive additional beams at a later time (after the first beam was received). The UE may be configured to identify one or more beams of the received beams to measure (and include in the beam report) based their relation to the time for the CSI reference resource that was determined in previous operation 610. The UE may be configured to determine which of the one or more beams were received before the determined time for the CSI reference resource (e.g., reporting timeline threshold), and identify these beams to be measured and included in the beam report to be transmitted in the second UL channel (e.g., satisfying the reporting timeline threshold). Alternatively, if the UE determines that a beam was received after the time for the CSI reference resource (e.g., failed the reporting timeline threshold) the UE may override (e.g., exclude) performing beam measurements on that beam, and therefore information related to that beam may not be included in the beam report.

Thereafter, at operation 620, measurements of the one or more beams identified in previous operation 615 may be obtained. In some embodiments, the UE device may be configured to perform beam-level measurements (on RSs for the beam) related to the quality of the received beam, including Reference Signal Received Power (RSRP), Reference Signal Received Power (RSRQ), Signal-to-Interference-plus-Noise Ratio (SINR). For example, if the UE determines that a beam was received before (e.g., in relation to) the determined time for the CSI reference resource relative the second UL channel, the UE may select the beam to have its beam measurements obtained and included in the beam report (e.g., UE initiated beam report).

At operation 625, the beam report which includes the measurements of the one or more beams performed in previous operation 620 may be transmitted. For example, the UE may transmit the beam report to the network (e.g., gNB) on the second UL channel. In some embodiments, the UE may be configured to execute one or more other content adjustment functions for the beam report based on a beams relation to the identified reference resource (e.g., report content dropping, transmission of reserved values, reporting the current beam RSRP measurement and ID, etc.), and/or additional functions as deemed appropriate.

Accordingly, the method 600 may implement UE-initiated beam reporting, including reporting timeline determination based on identifying a reference resource (e.g., relative to the second UL channel), in a manner that may mitigate invalidity and/or unreliability of the information that is communicated to the network via the UE-initiated beam report and increase the overall performance of the communication network with respect to various temporal considerations of UE-initiated beam reporting procedures, for example in environments where mobility and/or frequently changing conditions (e.g., channels, environments, etc.) may impact the beam reporting.

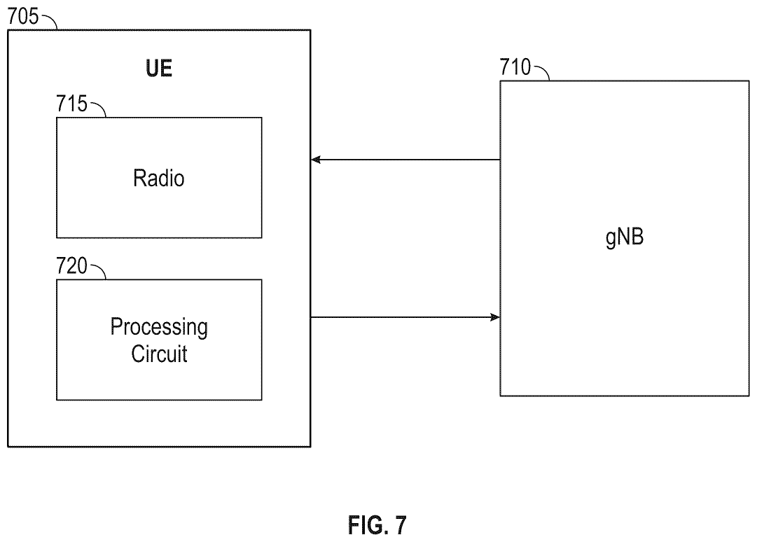

FIG. 7 illustrates a system including a UE 705 and a gNB 710 in communications with each other.

FIG. 7 shows a system including a UE 705 and a gNB 710, in communication with each other. The UE 905 may include a radio 915 and a processing circuit (or a means for processing) 920, which may perform various functions for UE-initiated beam reporting, including reporting time determination, as disclosed herein. For example, the UE 705 may implement the structure and functions of UE 112 as described in reference to FIG. 1; and the gNB 710 may implement the structure and functions of gNB 102 as described in reference to FIG. 1. The processing circuit 720 may receive, via the radio 715, transmissions from the network node (gNB) 710, and the processing circuit 720 may transmit, via the radio 715, signals to the gNB 710.

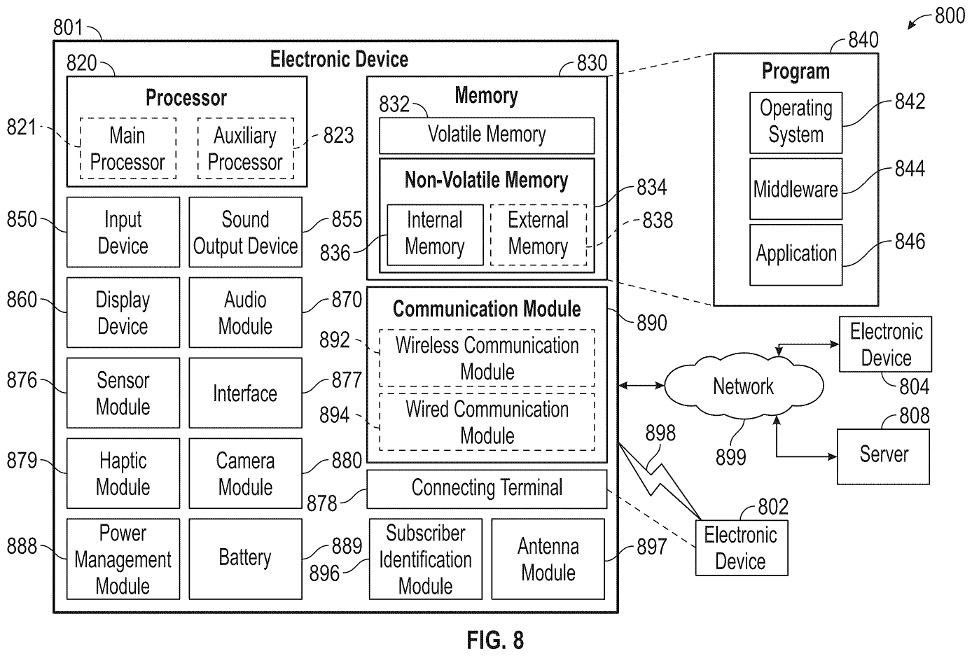

FIG. 8 is a block diagram of an electronic device, for example, a UE 112 (e.g., see FIG. 1) implementing measurement gap canceling, including processing time determination, according to some embodiments of the present disclosure. For example, processor 820 may include UE-initiated beam reporting circuit 150 (e.g., see FIG. 2) and perform the functions implementing UE-initiated beam reporting, including reporting timeline determination, as disclosed herein.

Referring to FIG. 8, an electronic device 801 in a network environment 800 may communicate with an electronic device 802 via a first network 898 (e.g., a short-range wireless communication network), or with an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, and/or an antenna module 897. In one embodiment, at least one of the components (e.g., the display device 860 or the camera module 880) may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled to the processor 820, and may perform various data processing or computations.

As at least part of the data processing or computations, the processor 820 may load a command or data received from another component (e.g., the sensor module 876 or the communication module 890) in volatile memory 832, may process the command or the data stored in the volatile memory 832, and may store resulting data in non-volatile memory 834. The processor 820 may include a main processor 821 (e.g., a central processing unit or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or to execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890), as opposed to the main processor 821 while the main processor 821 is in an inactive (e.g., sleep) state, or together with the main processor 821 while the main processor 1821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 860 may visually provide information to the outside (e.g., to a user) of the electronic device 801. The display device 860 may include, for example, a display, a hologram device, or a projector, and may include control circuitry to control a corresponding one of the display, hologram device, and projector. The display device 860 may include touch circuitry adapted to detect a touch, or may include sensor circuitry (e.g., a pressure sensor) adapted to measure the intensity of force incurred by the touch.

The audio module 870 may convert a sound into an electrical signal and vice versa. The audio module 870 may obtain the sound via the input device 850 or may output the sound via the sound output device 1855 or a headphone of an external electronic device 802 directly (e.g., wired) or wirelessly coupled to the electronic device 801.

The sensor module 876 may detect an operational state (e.g., power or temperature) of the electronic device 801, or an environmental state (e.g., a state of a user) external to the electronic device 801. The sensor module 876 may then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 877 may support one or more specified protocols to be used for the electronic device 801 to be coupled to the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected to the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus, which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power that is supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell that is not rechargeable, a secondary cell that is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808), and may support performing communication via the established communication channel. The communication module 890 may include one or more communication processors that are operable independently from the processor 820 (e.g., the AP), and may support a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)), or via the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas. The communication module 890 (e.g., the wireless communication module 1892) may select at least one of the one or more antennas appropriate for a communication scheme used in the communication network, such as the first network 1898 or the second network 899. The signal or the power may then be transmitted or received between the communication module 890 and the external electronic device via the selected at least one antenna.

Commands or data may be transmitted or received between the electronic device 801 and the external electronic device 804 via the server 808 coupled to the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively, or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, and their equivalents.

What is claimed is:

1. A method for transmitting a beam report using a first uplink channel and a second uplink channel, the method comprising:
transmitting a beam reporting indication message in the first uplink channel to initiate beam reporting;
identifying, at a User Equipment (UE), a reference resource based on the second uplink channel;
identifying one or more beams to measure based on a relation of the one or more beams to the reference resource;
performing measurements on the one or more beams; and
transmitting the beam report in the second uplink channel based on the measurement of the one or more beams.

2. The method of claim 1, wherein the reference resource comprises a Channel State Information (CSI) reference resource

3. The method of claim 2, wherein identifying the reference resource is based on determining a time for the CSI reference resource based on an aperiodic CSI reporting for the CSI reference resource

4. The method of claim 2, wherein identifying the reference resource is based on determining a time for the CSI reference resource relative to an uplink slot corresponding to the second uplink channel.

5. The method of claim 4, wherein determining the time for the CSI reference resource is based on a downlink slot corresponding to the CSI reference resource relative to the uplink slot.

6. The method of claim 5, wherein determining the time for the CSI reference resource is based on a subcarrier spacing configuration for the downlink slot and an offset value.

7. The method of claim 4, wherein identifying the one or more beams to measure is based on determining the one or more beams that are received at the UE before the determined time for the CSI reference resource.

8. A method for transmitting a beam report using a first uplink channel and a second uplink channel, the method comprising:
transmitting a beam reporting indication message in the first uplink channel to initiate beam reporting;
identifying, at a User Equipment (UE), a reference resource based on the first uplink channel;
identifying one or more beams to measure based on a relation of the one or more beams to the reference resource;
performing measurements on the one or more beams; and
transmitting the beam report in the second uplink channel based on the measurement of the one or more beams.

9. The method of claim 8, wherein the reference resource comprises a Channel State Information (CSI) reference resource.

10. The method of claim 9, wherein identifying the reference resource is based on determining a time for the CSI reference resource relative to a first symbol corresponding to the first uplink channel.

11. The method of claim 9, wherein identifying the one or more beams to measure is based on determining the one or more beams that are received at the UE before the determined time for the CSI reference resource.

12. A device for transmitting a beam report using a first uplink channel and a second uplink channel, the device comprising:
a processor; and
a memory storing instructions that, based on being executed by the processor, cause the processor to:
transmit a beam reporting indication message in the first uplink channel to initiate beam reporting;
identify a reference resource based on the second uplink channel;
identify one or more beams to measure based on a relation of the one or more beams to the reference resource;
perform measurements on the one or more beams; and
transmit the beam report in the second uplink channel based on the measurement of the one or more beams.

13. The device of claim 12, wherein the reference resource comprises a Channel State Information (CSI) reference resource.

14. The device of claim 13, wherein identifying the reference resource is based on determining a time for the CSI reference resource based on an aperiodic CSI reporting for the CSI reference resource.

15. The device of claim 14, wherein identifying the reference resource is based on determining a time for the CSI reference resource relative to an uplink slot corresponding to the second uplink channel.

16. The device of claim 15, wherein determining the time for the CSI reference resource is based on a downlink slot corresponding to the CSI reference resource relative to the uplink slot.

17. The device of claim 16, wherein determining the time for the CSI reference resource is based on a subcarrier spacing configuration for the downlink slot and an offset value.

18. The device of claim 17, wherein identifying the one or more beams to measure is based on determining the one or more beams that are received at the UE before the determined time for the CSI reference resource.

19. The device of claim 15, wherein identifying the reference resource is based on determining a time for the CSI reference resource relative to a first symbol in the uplink slot corresponding to the second uplink channel.

20. The device of claim 12, wherein the device comprises a User Equipment (UE) and the transmitting the beam report is to a general node B (gNB).
